(19) United States
(12) Patent Application Publication
(10) Pub. No.: US 2005/0030651 A1
(43) Pub. Date: Feb. 10, 2005

(54) Optical system and optical apparatus using the same

(75) Inventor: Kentaro Sekiyama, Tokyo-to (JP)

Correspondence Address: PILLSBURY WINTHROP, LLP, P.O. BOX 10500, MCLEAN, VA, 22102, US

(73) Assignee: Olympus Corporation, Tokyo (JP)

(21) Appl. No.: 10/735,853

(22) Filed: Dec. 16, 2003

(30) Foreign Application Priority Data
Dec. 17, 2002 (JP) 2002-365509

(51) Int. Cl. G02B 5/08

(52) U.S. Cl. 359/846; 359/852

(57) ABSTRACT

An optical system has at least one deformable mirror, a movable concave lens unit, and a convex lens unit. The deformable mirror is deformed and thereby focusing is performed.

### BACKGROUND OF THE INVENTION

1. Field of the Invention

This invention relates to an optical system used in an electronic imaging apparatus and an optical apparatus using this optical system.

2. Description of Related Art

A conventional optical system is provided with lens units that can be moved for focusing so that the lens units are moved along the optical axis by a driving means, such as a motor, and thereby an object is brought into a focus in accordance with a distance from the object to an imaging plane (an object distance).

### SUMMARY OF THE INVENTION

The present invention provides an optical system that has at least one deformable mirror and is constructed so that focusing can be performed by only the deformation of the deformable mirror. According to this construction, there is no need to drive lenses in focusing, and thus an optical system and an optical apparatus that are extremely low in power consumption, noiseless in operation, simple in mechanical structure, compact in design, and low in cost, can be realized.

According to the present invention, the deformable mirror has the advantage that it is deformed into a rotationally asymmetrical shape in a preset state in order to reduce decentering aberration. By this advantage, good imaging performance can be obtained in the whole focusing region. When the deformable mirror is deformed to have power, its reflecting surface is decentered with respect to incident light and therefore decentering aberration is produced on reflection. In order to correct this decentering aberration, it is desirable that the deformable mirror is deformed into the rotationally asymmetrical shape.

According to the present invention, in order to correct decentering aberration, at least one rotationally symmetrical lens or an imaging plane is placed so that it is decentered with respect to the Z axis. By this advantage, the deformable mirror is such that as its power is strengthened, the amount of residual decentering aberration increases. In such a case also, however, it becomes possible to obtain favorable optical performance. Also, in the present invention, decentering or decentration refers to a shift or tilt.

According to the present invention, the deformable mirror is constructed so that as the object distance for focusing is reduced, its positive power is increased. By this advantage, favorable optical performance can be obtained in a wide range from a far point to a near point. Also, in this specification, the signs of power are defined as plus when the mirror has a converging function and minus when it has a diverging function. That is, in the deformable mirror, as the amount of deformation of a concave surface is increased, the positive power is strengthened.

According to the present invention, the deformable mirror is designed so that either the positive power or the negative power can be assumed by deformation. By this design, favorable optical performance can be secured while suppressing the production of decentering aberration in the deformable mirror. That is, in the deformable mirror, the amount of deformation increases with increasing power and thereby decentering aberration is produced to cause the deterioration of optical performance. However, the deformable mirror has either the positive power or the negative power to thereby hold the amount of deformation, and favorable optical performance can be secured while suppressing the production of decentering aberration.

According to the present invention, the deformable mirror is also designed so that only the positive power can be assumed. By this design, mechanical and electrical structures are simplified, thus providing a deformable mirror of low cost.

According to the present invention, the deformable mirror is constructed so that when its mirror surface is deformed, the periphery of the mirror is fixed.

According to the present invention, the optical system and the optical apparatus using the optical system have at lest one cemented lens. This construction allows chromatic aberrations produced in individual lens units to be favorably corrected and is capable of contributing to a compact design of the optical system.

According to the present invention, when the maximum amount of deformation of the deformable mirror is represented by md and the focal length of the optical system is represented by fl, the optical system and the optical apparatus using the optical system satisfy the following condition in a preset state:
0<|md/fl|<0.1 (1-1)
Here, the focal length fl of the optical system is defined as that where the deformable mirror has a planar shape. The same holds for conditions to be described below.

By this condition, the amount of deformation of the deformable mirror can be kept within a proper limit. That is, beyond the upper limit of Condition (1-1), the amount of deformation of the deformable mirror is extremely increased and the amount of production of decentering aberration is increased. Consequently, it becomes difficult to fulfil desired optical performance. Moreover, the degree of difficulty of fabrication becomes remarkable.

According to the present invention, the optical system and the optical apparatus using the optical system satisfy the following condition in a preset state:
0<|md/fl|<0.05 (1-2)

By this condition, the amount of production of decentering aberration can be further held.

According to the present invention, the optical system and the optical apparatus using the optical system satisfy the following condition in a preset state:
0<|md/fl|<0.03 (1-3)

By this condition, the amount of production of decentering aberration can be more favorably held.

According to the present invention, when the area of an optically effective reflecting surface in the deformable mirror is denoted by Sm, the optical system and the optical apparatus using the optical system satisfy the following condition in a preset state:
0<md²/Sm<5.0×10⁻⁴ (2-1)

By this condition, the amount of deformation of the deformable mirror can be kept within a proper limit.

According to the present invention, the optical system and the optical apparatus using the optical system satisfy the following condition in a preset state:
0<md²/Sm<1.0×10⁻⁴ (2-2)

By this condition, the amount of deformation of the deformable mirror can be more favorably kept within a proper limit.

According the present invention, the optical system including the deformable mirror is such that the deformable mirror is drived by an electrostatic driving system in focusing, and when a voltage applied to the deformable mirror in focusing is represented by Vm (volt), the optical system satisfies the following condition in a preset state:
0≦|Vm|<500 (3-1)

By this condition, the dangerous property of atmospheric discharge is diminished and at the same time, the amount of deformation of the deformable mirror can be increased.

According to the present invention, the optical system and the optical apparatus using the optical system are such that the deformable mirror is driven by the electrostatic driving system when focusing is performed by the deformable mirror, and satisfies the following condition in a preset state:
0≦|Vm|<300 (3-2)

By this condition, power consumption can be lowered and thus the optical system and the optical apparatus that are more favorable can be provided.

According to the present invention, when the power of the deformable mirror is denoted by φDM, the optical system and the optical apparatus using the optical system satisfy the following condition in a preset state:
0≦|φDM×fl|<1.00 (4-1)
Here, the power φDM of the deformable mirror is the average value of a power φDMy in a plane in a decentering direction (the Y direction) of the deformable mirror and a power φDMx in a plane in a direction perpendicular to the Y direction (the X direction), and is defined as φDM=(φDMx+φDMy)/2.

By this condition, the focusing function of the deformable mirror can be satisfactorily performed, and decentering aberration produced in the deformable mirror can be kept within a proper limit.

According to the present invention, the optical system and the optical apparatus using the optical system satisfy the following condition in a preset state:
0≦|φDM×fl|<0.50 (4-2)

By this condition, decentering aberration produced in the deformable mirror can be further suppressed, which is more desirable.

According to the present invention, the optical system and the optical apparatus using the optical system satisfy the following condition in a preset state:
0≦|φDM×fl|<0.10 (4-3)

By this condition, decentering aberration produced in the deformable mirror can be more favorably suppressed.

According to the present invention, the optical system and the optical apparatus using the optical system have the advantage that when focusing is carried out at the far point by the deformable mirror, the deformable mirror can be deformed to have lower power than in focusing. By this advantage, an autofocus operation of the contrast system can be performed. Specifically, the deformable mirror has lower power than in focusing at the far point, and thereby the blurring of an image at the far point can be adjusted.

According to the present invention, the optical system and the optical apparatus using the optical system have the advantage that when focusing is carried out at the near point by the deformable mirror, the deformable mirror can be deformed to have higher power than in focusing.

By this advantage, the autofocus operation of the contrast system can be performed. Specifically, the deformable mirror has higher power than in focusing at the near point, and thereby the blurring of an image at the near point can be adjusted.

According to the present invention, the optical system and the optical apparatus using the optical system are such that when focusing is performed by the deformable mirror at the object point where the object distance is infinite, the deformable mirror is deformed not into a planar surface, but into a concave surface that has larger power than zero.

According to the present invention, the optical system and the optical apparatus using the optical system have a lens unit with negative power on the object side of the deformable mirror and satisfy the following condition:
−5.0<fl/fl<−0.2 (5-1)
where fl is the focal length of the lens unit.

By this condition, compactness, cost reduction, and favorable optical performance of the deformable mirror can be obtained. That is, below the lower limit of Condition (5-1), the power of the lens unit with negative power is extremely weakened, and the off-axis ray height of the deformable mirror at the wide-angle position cannot be decreased. This leads to oversizing of the deformable mirror and raises cost. Beyond the upper limit of Condition (5-1), the power of the lens unit with negative power is extremely strengthened, and it becomes difficult to correct coma and chromatic aberration of magnification, produced in the lens unit.

According to the present invention, the optical system and the optical apparatus using the optical system satisfy the following condition:
−2.5<fl/fl<−0.5 (5-2)

By this condition, favorable optical performance is ensured and at the same time, further compactness of the deformable mirror can be achieved, which is more desirable.

According to the present invention, the optical system and the optical apparatus using the optical system have the advantage that the lens unit with negative power, located on the object side of the deformable mirror, is constructed with a single concave lens. By this advantage, a compact- and slim-design optical system can be achieved because only one lens is placed on the object side of the deformable mirror.

According to the present invention, the optical system and the optical apparatus using the optical system have the advantage that the lens unit with negative power, located on the object side of the deformable mirror, is constructed with two lenses. By this advantage, the optical system and the optical apparatus using the optical system that excel in the ability to correct aberrations, such as distortion and chromatic aberration of magnification, can be realized.

According to the present invention, when an angle where an axial chief ray is bent by the deformable mirror is denoted by 0, the optical system and the optical apparatus using the optical system satisfy the following condition:
60°<θ<120° (6-1)

Below the lower limit of Condition (6-1), the longitudinal dimension of the deformable mirror must be increased and a cost reduction becomes difficult. Beyond the upper limit of Condition (6-1), the size of the mirror is reduced, but lens units located in front of and behind the deformable mirror interfere with each other, and the arrangement of the optical system is rendered difficult. Also, the chief ray described here refers to a ray that emerges from the center of the object, passes through the center of a stop, and reaches the center of an image.

According to the present invention, the optical system and the optical apparatus using the optical system satisfy the following condition:
75°<θ<105° (6-2)

By this condition, a better result is brought about.

According to the present invention, when the magnification of a lens unit ranging from an optical surface situated immediately behind the deformable mirror to the last surface is represented by β1, the optical system and the optical apparatus using the optical system satisfy the following condition:
0.35<|β1|<1.50 (7-1)

Below the lower limit of Condition (7-1), the magnification of the lens unit located behind the deformable mirror becomes so low that a focus sensitivity of the deformable mirror is impaired and the amount of deformation of the deformable mirror required for focusing is increased. Beyond the upper limit of Condition (7-1), the magnification of the lens unit is so high that decentering aberration produced in the deformable mirror is increased and it becomes difficult to obtain satisfactory optical performance.

According to the present invention, the optical system and the optical apparatus using the optical system satisfy the following condition:
0.50<|β1|<1.20 (7-2)

By this condition, the amount of deformation of the deformable mirror can be kept within a proper limit while ensuring optical performance, and thus a better result is brought about.

According to the present invention, when the overall length of the optical system is denoted by Cj, the optical system and the optical apparatus using the optical system satisfy the following condition:
1.0<Cj/fl<20.0 (8-1)

Beyond the upper limit of Condition (8-1), the overall length of the optical system is extremely increased and compactness of the optical system becomes difficult. Below the lower limit of Condition (8-1), the compactness is attained, but the arrangement of lens units is limited and satisfactory optical performance cannot be obtained.

According to the present invention, the optical system and the optical apparatus using the optical system satisfy the following condition:
3.0<Cj/fl<15.0 (8-2)

By this condition, a compact optical system and higher optical performance can be obtained.

According to the present invention, the optical system and the optical apparatus using the optical system satisfy the following condition:
5.0<Cj/fl<10.0 (8-3)

By this condition, a better result is brought about.

According to the present invention, the optical system and the optical apparatus using the optical system are such that at least one lens is shifted in order to correct decentering aberration produced by the deformable mirror, and satisfy the following condition in a preset state:
0.0≦|δ/fl|<1.00 (9-1)
where δ is the amount of shift of the lens.

By this condition, the amount of decentration applied to the lens can be kept within a proper limit, and the balance of optical performance between a weak power and a strong power of the deformable mirror can be held. Here, the amount of shift δ refers to the amount defined as a distance between the center axis of the shifted lens and the Z axis of the optical system.

According to the present invention, the optical system and the optical apparatus using the optical system satisfy the following condition in a preset state:
0.0≦|δ/fl|<0.50 (9-2)

By this condition, performance in focusing at the far and near points can be further improved.

According to the present invention, the optical system and the optical apparatus using the optical system satisfy the following condition in a preset state:
0.0≦|δ/fl|<0.25 (9-3)

By this condition, a better result is brought about.

According to the present invention, the optical system and the optical apparatus using the optical system are such that a lens unit with negative power, placed on the object side of the deformable mirror, is constructed with two lenses, and satisfy the following condition:
δ₁×δ₂≦0 (9-4)
where δ₁ and δ₂ are shifts applied to the two lenses.

By this condition, that is, by reversing the directions of the shifts applied to the lens unit with negative power, a considerable effect is brought about on correction for decentering aberration produced in the deformable mirror.

According to the present invention, the optical system and the optical apparatus using the optical system are such that at least one lens or an imaging plane is tilted in order to correct decentering aberration produced by the deformable mirror, and satisfy the following condition in a preset state:
0.0°≦|ε|<10.00 (10-1)
where ε is the amount of tilt applied to the lens or the imaging plane.

By this condition, the amount of decentration applied to the lens can be kept within a proper limit, and the balance of optical performance between a weak power and a strong power of the deformable mirror can be held. Here, the amount of tilt ε refers to the amount defined as a tilt angle made by the center axis of the tilted lens or imaging plane with the Z axis of the optical system.

According to the present invention, the optical system and the optical apparatus using the optical system satisfy the following condition in a preset state:
0.0°≦|ε|<7.00 (10-2)

By this condition, performance in focusing at the far and near points can be further improved.

According to the present invention, the optical system and the optical apparatus using the optical system satisfy the following condition in a preset state:
0.0°≦|ε|<5.50 (10-3)

By this condition, a better result is brought about.

According to the present invention, the optical system and the optical apparatus using the optical system have the advantage that, of the absolute values of the amounts of tilt applied to individual lenses or the imaging plane, the absolute value of the amount of tilt of the imaging plane is largest.

According to the present invention, the optical system and the optical apparatus using the optical system have the advantage that the direction of tilt applied to the imaging plane is a direction approaching parallel to the deformable mirror.

According to the present invention, the optical system and the optical apparatus using the optical system have the advantage that, in the optical system in which the shift and tilt are applied to at least one lens or an imaging plane in order to correct decentering aberration produced by the deformable mirror, the shift takes place in a certain plane and the rotary axis of the tilt is perpendicular to the plane.

According to the present invention, the optical system and the optical apparatus using the optical system are such that the stop is placed on the image side of the deformable mirror.

According to the present invention, the optical system that affords a small number of moving lens units, a compact design, low power consumption, and noiseless operation, and the optical apparatus using the optical system, can be provided.

These and other features and advantages of the present invention will become apparent from the following detailed description of the preferred embodiments when taken in conjunction with the accompanying drawings.

### BRIEF DESCRIPTION OF THE DRAWINGS

FIG. 1 is a Y-Z sectional view showing the optical system of a first embodiment in the present invention;

FIG. 2 is a diagram showing transverse aberrations at infinity of an object point distance in the first embodiment;

FIG. 3 is a diagram showing transverse aberrations at an object point distance of 150 mm in the first embodiment;

FIG. 4 is a Y-Z sectional view showing the optical system of a second embodiment in the present invention;

FIG. 5 is a diagram showing transverse aberrations at infinity of the object point distance in the second embodiment;

FIG. 6 is a diagram showing transverse aberrations at an object point distance of 180 mm in the second embodiment;

FIG. 7 is a Y-Z sectional view showing the optical system of a third embodiment in the present invention;

FIG. 8 is a diagram showing transverse aberrations at infinity of the object point distance in the third embodiment;

FIG. 9 is a diagram showing transverse aberrations at an object point distance of 150 mm in the third embodiment;

FIG. 10 is a view schematically showing a Keplerian finder for a digital camera using a variable optical-property mirror as a deformable mirror applicable to the present invention;

FIG. 11 is a view schematically showing another example of a variable mirror applicable as the deformable mirror used in the present invention;

FIG. 12 is an explanatory view showing one aspect of electrodes used in the example of FIG. 11;

FIG. 13 is an explanatory view showing another aspect of electrodes used in the example of FIG. 11;

FIG. 14 is a view schematically showing another example of the variable mirror applicable as the deformable mirror used in the present invention;

FIG. 15 is a view schematically showing another example of the variable mirror applicable as the deformable mirror used in the present invention;

FIG. 16 is a view schematically showing another example of the variable mirror applicable as the deformable mirror used in the present invention;

FIG. 17 is an explanatory view showing the winding density of a thin-film coil in the example of FIG. 16;

FIG. 18 is a view schematically showing still another example of the variable mirror applicable as the deformable mirror used in the present invention;

FIG. 19 is an explanatory view showing one example of an array of coils in the example of FIG. 18;

FIG. 20 is an explanatory view showing another example of an array of coils in the example of FIG. 18;

FIG. 21 is an explanatory view showing an array of permanent magnets suitable for the array of coils of FIG. 20 in the example of FIG. 16;

FIG. 22 is a view schematically showing an imaging system which uses the variable mirror as the deformable mirror applicable to an imaging apparatus using the optical system of the present invention;

FIG. 23 is a view schematically showing still another example of the variable mirror applicable as the deformable mirror used in the present invention;

FIG. 24 is a view schematically showing one example of a micropump applicable to the deformable mirror used in the present invention;

FIG. 25 is a view showing a variable focal-length mirror in which a variable focal-length lens is applied, applicable to the present invention; and

FIG. 26 is a view schematically showing still another example of the variable mirror applicable as the deformable mirror used in the present invention.

### DETAILED DESCRIPTION OF THE PREFERRED EMBODIMENTS

In accordance with the embodiments shown in the drawings, the present invention will be described below. Before undertaking the explanation of the embodiments, it will be worthwhile to describe a free-formed surface defined by the following equation. The Z axis in this defining equation corresponds to the axis of the free-formed surface.

$$Z = {cr}^{2} / [ 1 + \sqrt{\{ 1 - ( 1 + k ) {c}^{2} {r}^{2} \}} ] + {\sum }_{j = 2 - 66}^{N} {C}_{j} {X}^{m} {Y}^{n} \qquad ( a )$$

Here, the first term of this equation is a spherical surface term, and the second term is a free-formed surface term.

In the spherical surface term,
c: curvature of the vertex,
k: conic constant,
r=\sqrt{(X²+Y²)}
N: natural number of 2 or larger

The free-formed surface term is as follows:

$${\sum }_{j = 2 - 66}^{N} {C}_{j} {X}^{m} {Y}^{n} = {C}_{2} X + {C}_{3} Y + {C}_{4} {X}^{2} + {C}_{5} XY + {C}_{6} {Y}^{2} + {C}_{7} {X}^{3} + {C}_{8} {X}^{2} Y + {C}_{9} {XY}^{2} + {C}_{10} {Y}^{3} + {C}_{11} {X}^{4} + {C}_{12} {X}^{3} Y + {C}_{13} {X}^{2} {Y}^{2} + {C}_{14} {XY}^{3} {C}_{15} {Y}^{4} + {C}_{16} {X}^{5} + {C}_{17} {X}^{4} Y + {C}_{18} {X}^{3} {Y}^{2} + {C}_{19} {X}^{2} {Y}^{3} + {C}_{20} {XY}^{4} + {C}_{21} {Y}^{5} + {C}_{22} {X}^{6} + {C}_{23} {X}^{5} Y + {C}_{24} {X}^{4} {Y}^{2} + {C}_{25} {X}^{3} {Y}^{3} + {C}_{26} {X}^{2} {Y}^{4} + {C}_{27} {XY}^{5} + {C}_{28} {Y}^{6} + {C}_{29} {X}^{7} + {C}_{30} {X}^{6} Y + {C}_{31} {X}^{5} {Y}^{2} + {C}_{32} {X}^{4} {Y}^{3} + {C}_{33} {X}^{3} {Y}^{4} + {C}_{34} {X}^{2} {Y}^{5} + {C}_{35} {XY}^{6} + {C}_{36} {Y}^{7} …$$

where Cⱼ (j is an integer of 2 or larger) is a coefficient.

The above-mentioned free-formed surface never generally has a symmetric surface for both the X-Z plane and the Y-Z plane. However, by bringing all odd-number order terms of X to 0, a free-formed surface having only one symmetrical surface parallel to the Y-Z plane is obtained. By bringing all odd-number order terms of Y to 0, a free-formed surface having only one symmetrical surface parallel to the X-Z plane is obtained.

The free-formed surface of rotationally asymmetrical curved shape, mentioned above, can also be defined by the Zernike polynomial as another defining equation. The configuration of this surface is defined by the following equation. The Z axis of this equation corresponds to the axis of the Zemike polynomial. The rotationally asymmetrical surface is defined by polar coordinates of a height from the Z axis relative to the X-Y plane, where R is a distance from the Z axis in the X-Y plane, and A is an azimuth around the Z axis and is expressed by an rotating angle measured from the Z axis.

$$X = R \times cos ( A ) \\ Y = R \times sin ( A ) \\ Z = {D}_{2} + {D}_{3} R cos ( A ) + {D}_{4} R sin ( A ) + {D}_{5} {R}^{2} cos ( 2 A ) + {D}_{6} ( {R}^{2} - 1 ) + {D}_{7} {R}^{2} sin 2 A ) + {D}_{8} {R}^{3} cos ( 3 A ) + {D}_{9} ( 3 {R}^{3} - 2 R ) cos ( A ) + {D}_{10} ( 3 {R}^{3} - 2 R ) sin ( A ) + {D}_{11} {R}^{3} sin ( 3 A ) + {D}_{12} {R}^{4} cos ( 4 A ) + {D}_{13} ( 4 {R}^{4} - 3 {R}^{2} ) cos ( 2 A ) + {D}_{14} ( 6 {R}^{4} - 6 {R}^{2} + 1 ) + {D}_{15} ( 4 {R}^{4} - 3 {R}^{2} ) sin ( 2 A ) + {D}_{16} {R}^{4} sin ( 4 A ) + {D}_{17} {R}^{5} cos ( 5 A ) + {D}_{18} ( 5 {R}^{5} - 4 {R}^{3} ) cos ( 3 A ) + {D}_{19} ( 10 {R}^{5} - 12 {R}^{3} + 3 R ) cos ( A ) + {D}_{20} ( 10 {R}^{5} - 12 {R}^{3} + 3 R ) sin ( A ) + {D}_{21} ( 5 {R}^{5} - 4 {R}^{3} ) sin ( 3 A ) + {D}_{22} {R}^{5} sin ( 5 A ) + {D}_{23} {R}^{6} cos ( 6 A ) + {D}_{24} ( 6 {R}^{6} - 5 {R}^{4} ) cos ( 4 A ) + {D}_{25} ( 15 {R}^{6} - 20 {R}^{4} + 6 {R}^{2} ) cos ( 2 A ) + {D}_{26} ( 20 {R}^{6} - 30 {R}^{4} + 12 {R}^{2} - 1 ) + {D}_{27} ( 15 {R}^{6} - 20 {R}^{4} + 6 {R}^{2} ) sin ( 2 A ) + {D}_{28} ( 6 {R}^{6} - 5 {R}^{4} ) sin ( 4 A ) + {D}_{29} {R}^{6} sin ( 6 A ) … \qquad ( b )$$

where Dₘ (m is an integer of 2 or larger) is a coefficient. Also, in order to make a design as an optical system symmetrical with respect to the X axis, D₄, D₅, D₆, D₁₀, D₁₁, D₁₂, D₁₃, D₁₄, D₂₀, D₂₁, D₂₂, . . . are used.

The above defining equation is shown to give an example of the configuration of the rotational asymmetrical curved surface, and it is needless to say that the same effect is secured with respect to any other defining equation. If mathematically identical values are given, the configuration of the curved surface may be expressed by another definition.

In the present invention, all odd-number order terms of X in Equation (a) are brought to zero and thereby the free-formed surface that has a symmetrical surface parallel to the Y-Z plane is obtained.

Also, when Z is taken as the coordinate in the direction of the optical axis, Y is taken as the coordinate normal to the optical axis, k represents a conic constant, and a, b, c, and d represent aspherical coefficients, the configuration of an aspherical surface is expressed by the following equation:
Z=(Y²/r)/[1+{1−(1+k)(Y/r)²}^{1/2}]+ay⁴+by⁶+cy⁸+dy¹⁰ (c)

These symbols are also used for the numerical data of the embodiments to be described later.

In the embodiments, “ASP” denotes an aspherical surface, “FFS” denotes a free-formed surface, and “DM” denotes a deformable mirror. The terms relative to the aspherical surface and the free-formed surface that are not set forth in the data are zero. The refractive index and the Abbe's number are described with respect to the d line (wavelength 587.56 nm). The length is expressed in millimeters (mm) and the angle in degrees (deg). Also, although two plane-parallel plates are arranged on the most image-plane side in each of the embodiments, they are assumed as the cover glass of an image sensor, an IR cutoff filter, and a low-pass filter.

In each embodiment, the Z axis of the coordinate system on the surface of an object is defined as a straight line perpendicular to the surface of the object, passing through the center of the object. The Y axis is taken as the coordinate normal to the Z axis, and the X axis is taken as an axis constituting a right-handed coordinate system together with the Y axis and the Z axis. The optical axis is defined as the path of a ray of light passing through the centers of the surface of the object and the stop or the exit pupil. Thus, the optical axis is changed with the deformation of the deformable mirror, but this change is slight in most cases. Consequently, the Z axis practically coincides with the optical axis in each embodiment.

A decentering surface is given by the shift of the vertex position of this surface (the directions of X, Y, and Z axes are denoted by X, Y, and Z, respectively) from the origin of the coordinate system and by the tilt (α, β, and γ (deg)) of the center axis of the surface (the Z axis of Equation (a) in the free-formed surface), with the X, Y, and Z axes as centers. When a surface to be decentered is called a k surface, the origin of the coordinate system where decentration takes place is defined as a point shifted from the vertex position of a k−1 surface along the Z axis for surface-to-surface spacing. The decentration takes place in order of X shift, Y shift, Z shift, α tilt, β tilt, and γ tilt. In this case, the plus sign of each of α and β indicates a counterclockwise direction where each of the X axis and the Y axis is viewed from a minus side, and the plus sign of y indicates a clockwise direction where the Z axis is viewed from a minus direction.

Also, in each embodiment, there are two kinds of decentration, decenter-andreturn (DAR) and decenter-only (DEO). In the DAR, when the k surface has been decentered, each of the coordinate systems of a k+1 surface and surfaces lying behind it coincides with that of the k surface before decentration. The vertex position of the k+1 surface is defined as a point shifted from that of the k surface before decentration along the Z axis for surface-to-surface spacing. In the DEO, on the other hand, when the k surface has been decentered, each of the coordinate systems of the k+1 surface and surfaces lying behind it coincides with that of the k surface after decentration. The vertex position of the k+1 surface is defined as a point shifted from that of the k surface after decentration along the Z axis for surface-to-surface spacing.

The positive direction of the Z axis of the coordinate system of a reflecting surface refers to a direction in which the axis travels from the obverse of the reflecting surface toward the reverse. Thus, when the reflecting surface is changed into the free-formed surface shape expressed by the X-Y polynomial and the power components C₄ and C₆ are positive, the reflecting surface becomes a convex mirror, that is, a mirror with negative power. Conversely, when the power components C₄ and C₆ are negative, a concave mirror, that is, a mirror with positive power, is obtained. The coordinate system of the optical system after a light ray is reflected by the reflecting surface corresponds to the case where the coordinate system before the ray is reflected is rotated by 180° about the X axis. Whereby, the ray always travels along the positive direction of the Z axis of the optical system.

The deformable mirror is capable of changing the power to perform focusing from the far point to the near point, but is designed to bring about a state of weaker power than in focusing at the far point and a state of stronger power than in focusing at the near point in order to perform auto-focusing of a contrast method. In each embodiment to be described below, the state of weaker power than in focusing at the far point is defined as far-point allowance, and a state of stronger power than in focusing at the near point is defined as near-point allowance. That is, the deformable mirror has four states, the far-point allowance, the far point, the near point, and the near-point allowance.

The deformable mirror in each embodiment is designed to have an allowance for the amount of deformation before and after focusing range, in view of the shift of the image plane in the Z direction caused by a fabrication error in actual fabrication and by a temperature change.

In each embodiment, the optical system is such that the deformable mirror has a focusing function. Since focusing can be performed without mechanical drive, a lens frame structure is simplified and a compact design and a cost reduction can be attained. Moreover, there is the merit of eliminating the driving noise of a motor in focusing.

First Embodiment

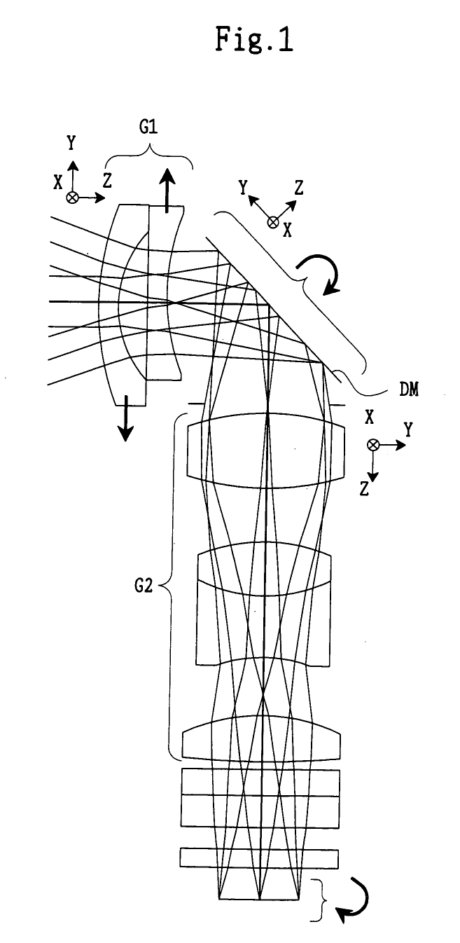

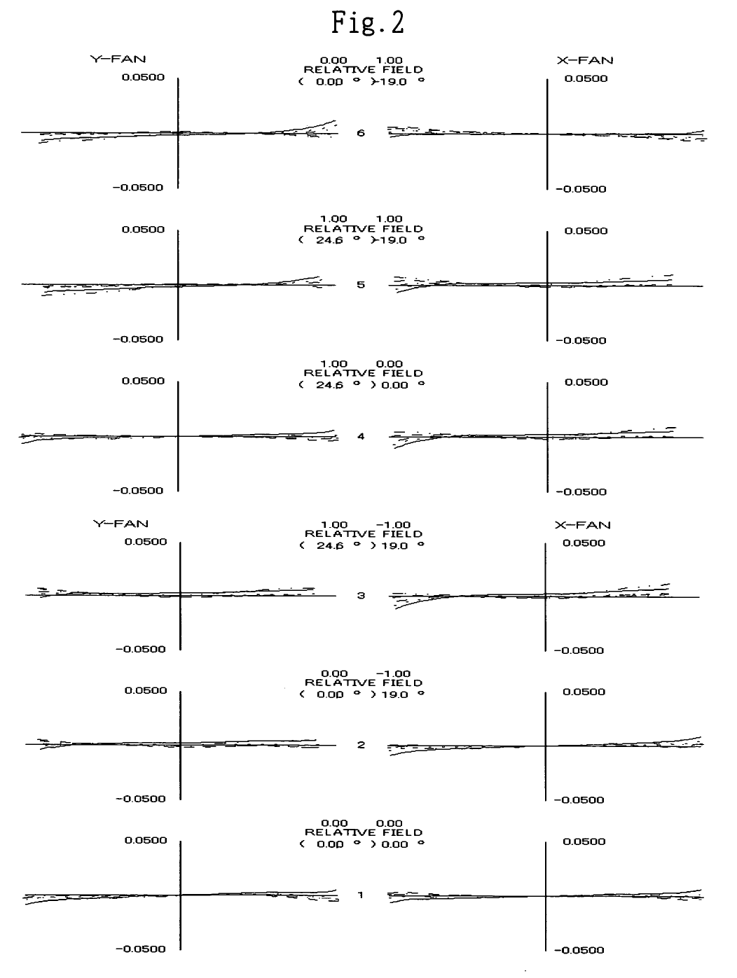

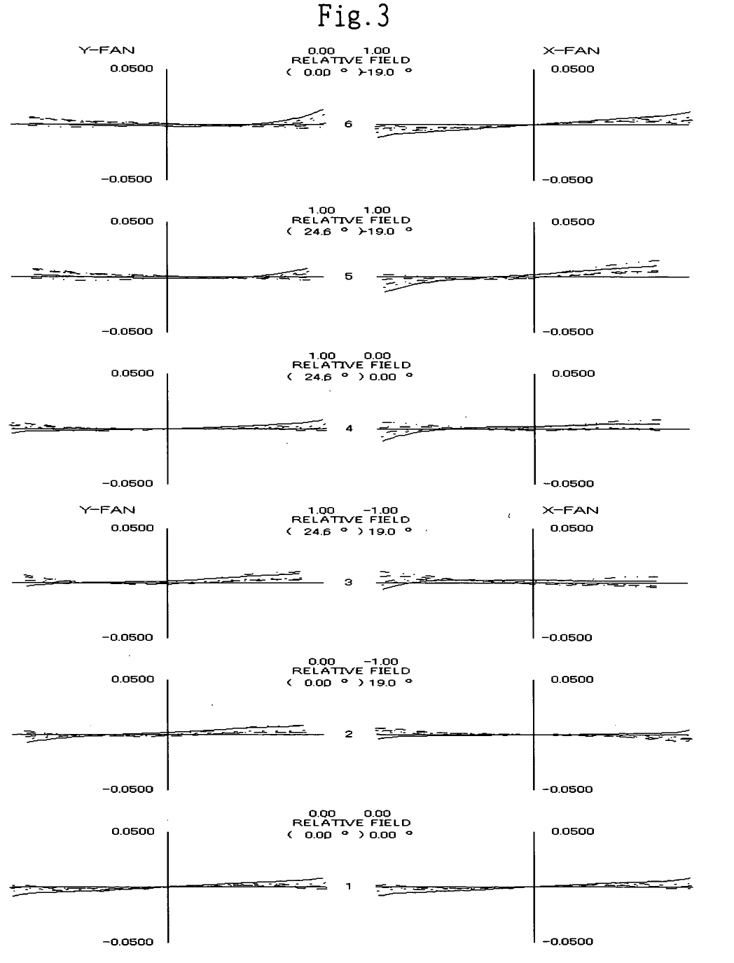

FIG. 1 shows the optical system of the first embodiment in the present invention. FIG. 2 shows transverse aberrations at infinity of an object point distance in the first embodiment. FIG. 3 shows transverse aberrations at an object point distance of 150 mm in the first embodiment. Also, in FIG. 1, each of arrows indicates the direction of decentration of an optical member.

The optical system of the first embodiment, as shown in FIG. 1, includes a deformable mirror DM; a concave lens unit G1 with two lens components composed of two lens elements, located on the object side of the deformable mirror DM; and a convex lens unit G2 with three lens components composed of four lens elements, located on the image side of the deformable mirror DM. The deformable mirror DM is deformed and thereby focusing can be performed from the infinity to the near point of a distance of 150 mm.

When the deformable mirror DM is deformed from a planar surface to a curved surface, decentering aberration is produced by reflection from a mirror surface. In particular, when focusing is carried out at the near point where the amount of deformation of the deformable mirror DM is appreciable, the decentering aberration is increased. In this embodiment, to obtain favorable optical performance in the range from the far point to the near point, shift and tilt decentration is applied to a lens unit or an imaging plane. Whereby, the production of decentering aberration in focusing can be balanced.

Subsequently, numerical data of optical members constituting the optical system of the first embodiment are shown below.
Focal length: 4.9 mm (38 mm in terms of silver halide)
Open F-number: 2.8

Size of imaging plane: 4.4 mm×3.3 mm

| | Radius of | Surface | | Refractive | |
|---|---|---|---|---|---|
| Surface number | curvature | spacing | Decentration | index | Abbe's number |
| Object surface | ∞ | ∞ | | | |
| 1 | 10.662 | 0.800 | | 1.7725 | 49.6 |
| 2 | 4.300 | 1.200 | | | |
| 3 | ∞ | 0.800 | Decentration (1) | 1.4875 | 70.2 |
| 4 | 8.675 | 4.200 | | | |
| 5 | ∞ | 0.000 | Decentration (2) | | |
| 6 | FFS [1] | 0.000 | Decentration (3) | | |
| 7 | ∞ | 4.000 | Decentration (4) | | |
| 8 (stop surface) | ∞ | 0.300 | | | |
| 9 | 9.498 | 2.979 | | 1.7433 | 49.3 |
| 10 | ASP [1] | 2.160 | | | |
| 11 | 7.565 | 2.144 | | 1.5163 | 64.1 |
| 12 | −6.294 | 2.427 | | 1.8052 | 25.4 |
| 13 | 6.285 | 2.279 | | | |
| 14 | 7.348 | 1.841 | | 1.5831 | 59.4 |
| 15 | ASP [2] | 0.300 | | | |
| 16 | ∞ | 1.000 | | 1.5163 | 64.1 |
| 17 | ∞ | 1.290 | | 1.5477 | 62.8 |
| 18 | ∞ | 0.800 | | | |
| 19 | ∞ | 0.750 | | 1.5163 | 64.1 |
| 20 | ∞ | 1.100 | | | |
| Image plane | ∞ | 0.000 | Decentration (5) | | |

Aspherical coefficients
ASP [1]

| | | |
|---|---|---|
| Radius of curvature | −12.103 | k = 0 |
| a = 3.3665 × 10⁻⁴ | b = −1.9533 × 10⁻⁶ | c = 2.8491 × 10⁻⁷ |
| d = −3.8724 × 10⁻⁹ | | |

ASP [2]

| | | |
|---|---|---|
| Radius of curvature | −20.000 | k = 0 |
| a = 1.0418 × 10⁻³ | b = 3.1010 × 10⁻⁵ | c = −3.6437 × 10⁻⁶ |
| d = 1.5524 × 10⁻⁷ | | |

Amount of decentration
Decentration [1] (DEO)

| | | | | |
|---|---|---|---|---|
| X = 0.000 | Y = 0.500 | Z = 0.000 | α = 0.000 | β = 0.000 |
| γ = 0.000 | | | | |

Decentration [2] (DEO)

| | | | | |
|---|---|---|---|---|
| X = 0.000 | Y = −0.393 | Z = 0.000 | α = 45.000 | β = 0.000 |
| γ = 0.000 | | | | |

Decentration [3] (DAR)

| | | | | |
|---|---|---|---|---|
| X = 0.000 | Y = −0.351 | Z (described | α = −0.206 | β = 0.000 |
| γ = 0.000 | | in FFS [1]) | | |

Decentration [4] (DEO)

| | | | | |
|---|---|---|---|---|
| X = 0.000 | Y = 0.000 | Z = 0.000 | α = 45.000 | β = 0.000 |
| γ = 0.000 | | | | |

Decentration [5] (DAR)

| | | | | |
|---|---|---|---|---|
| X = 0.000 | Y = −0.006 | Z = 0.000 | α = −1.000 | β = 0.000 |
| γ = 0.000 | | | | |

FFS [1]

| | ∞ allowance | ∞ | 150 mm | 150 mm allowance |
|---|---|---|---|---|
| C4 | −0.3190 × 10⁻⁵ | −0.4772 × 10⁻³ | −0.1053 × 10⁻² | −0.1588 × 10⁻² |
| C6 | −0.3179 × 10⁻⁴ | −0.2419 × 10⁻³ | −0.5251 × 10⁻³ | −0.7847 × 10⁻³ |
| C8 | −0.1845 × 10⁻⁴ | −0.2699 × 10⁻⁴ | −0.4654 × 10⁻⁴ | −0.7368 × 10⁻⁴ |
| C10 | 0.4599 × 10⁻⁵ | −0.1093 × 10⁻⁴ | −0.2621 × 10⁻⁴ | −0.4104 × 10⁻⁴ |
| C11 | 0.9450 × 10⁻⁵ | 0.7951 × 10⁻⁵ | 0.4889 × 10⁻⁵ | 0.7148 × 10⁻⁵ |
| C13 | 0.4646 × 10⁻⁵ | 0.5149 × 10⁻⁵ | 0.3726 × 10⁻⁵ | 0.7462 × 10⁻⁵ |
| C15 | 0.3176 × 10⁻⁵ | 0.5839 × 10⁻⁶ | −0.4205 × 10⁻⁶ | −0.4914 × 10⁻⁶ |
| Z | 0.00040 | 0.00309 | 0.00760 | 0.01042 |

TABLE 1

| | | Z1 | Z2 | Z3 | Z4 |
|---|---|---|---|---|---|
| Object distance | | ∞ allowance | ∞ | 150 mm | 150 mm allowance |
| φDMx [1/mm] | | −3.190E−06 | −4.772E−04 | −1.053E−03 | −1.588E−03 |
| φDMy [1/mm] | | −3.179E−05 | −2.419E−04 | −5.251E−04 | −7.847E−04 |
| md [mm] | | 4.000E−04 | 3.090E−03 | 7.600E−03 | 1.042E−02 |
| β1 | Condition 7 | −0.821 | −0.821 | −0.820 | −0.820 |
| fl [mm] | | 4.961 | 4.958 | 4.954 | 4.951 |
| Cj [mm] | | 30.500 | 30.500 | 30.500 | 30.500 |
| Sm [mm²] | | 25.525 | 25.525 | 25.525 | 25.525 |
| f 1 [mm] | | −6.039 | −6.039 | −6.039 | −6.039 |
| δ [mm] | | 0.500 | 0.500 | 0.500 | 0.500 |
| ε [deg] | Condition 10 | −1.000 | −1.000 | −1.000 | −1.000 |
| \|md/fl\| | Condition 1 | 8.063E−05 | 6.232E−04 | 1.534E−03 | 2.104E−03 |
| md²/Sm | Condition 2 | 6.268E−09 | 3.741E−07 | 2.263E−06 | 4.254E−06 |
| \|φDM × fl\| | Condition 4 | 8.676E−05 | 1.783E−03 | 3.909E−03 | 5.874E−03 |
| f 1/fl | Condition 5 | −1.217 | −1.218 | −1.219 | −1.220 |
| Cj/fl | Condition 8 | 6.148 | 6.151 | 6.157 | 6.160 |
| \|δ/fl\| | Condition 9 | 0.101 | 0.101 | 0.101 | 0.101 |

Second Embodiment

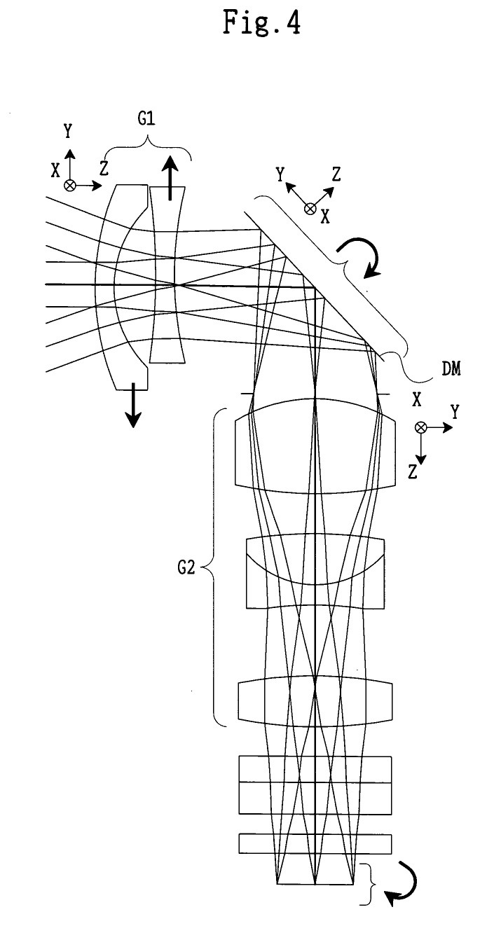

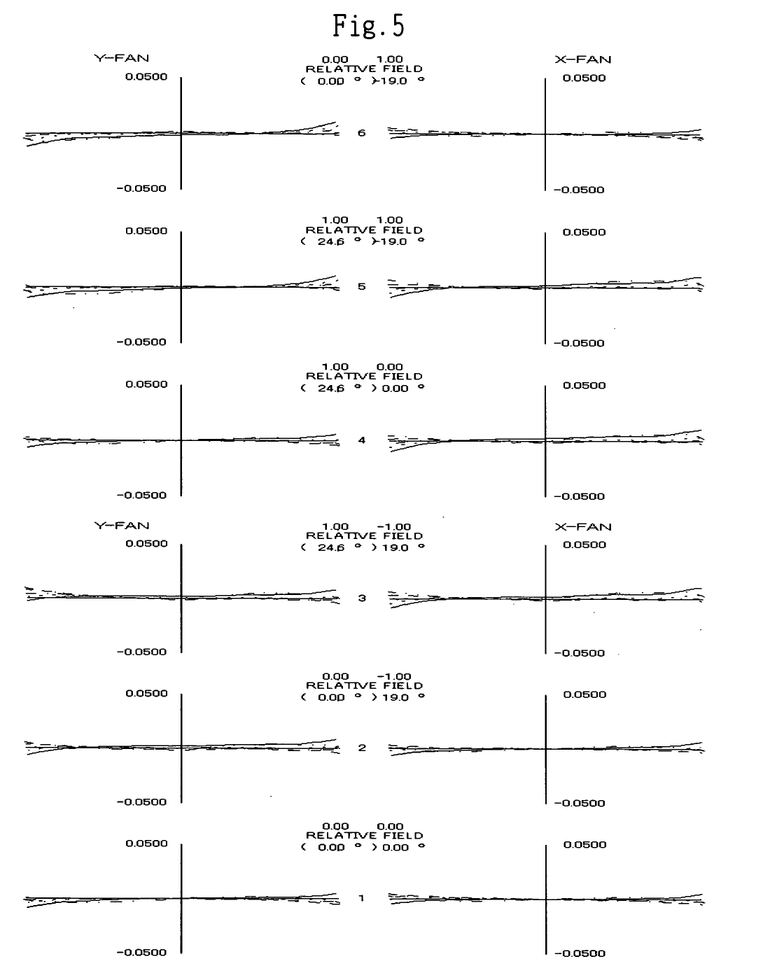

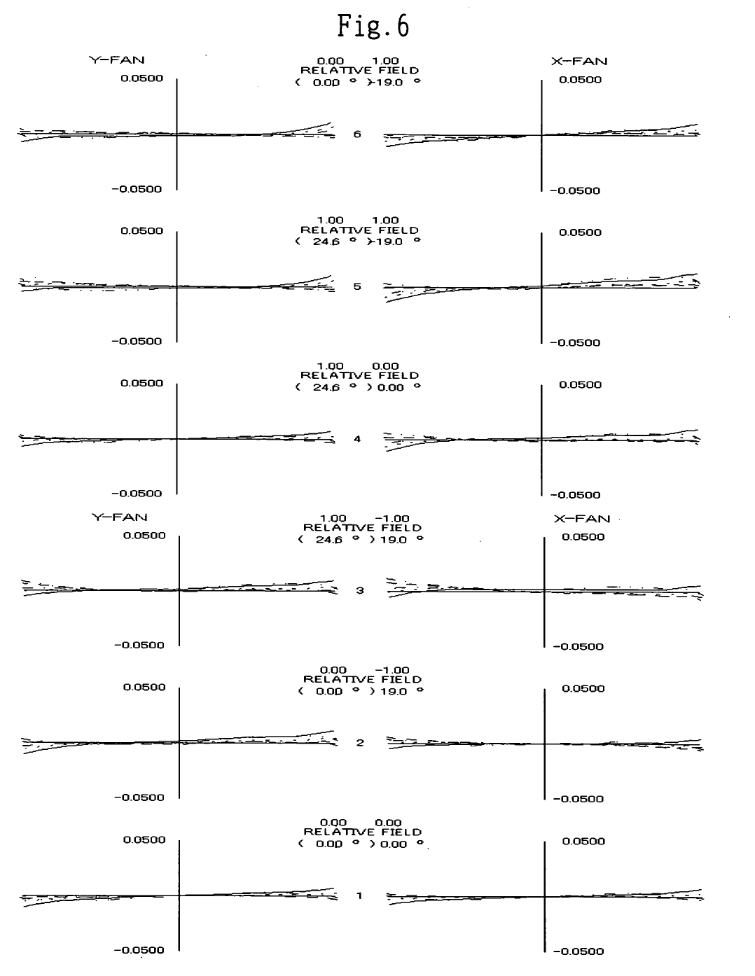

FIG. 4 shows the optical system of the second embodiment in the present invention. FIG. 5 shows transverse aberrations at infinity of an object point distance in the second embodiment. FIG. 6 shows transverse aberrations at an object point distance of 180 mm in the second embodiment. Also, in FIG. 4, each of arrows indicates the direction of decentration of an optical member.

The optical system of the second embodiment, as shown in FIG. 4, includes a deformable mirror DM; a concave lens unit G1 with two lens components composed of two lens elements, located on the object side of the deformable mirror DM; and a convex lens unit G2 with three lens components composed of four lens elements, located on the image side of the deformable mirror DM. The deformable mirror DM is deformed and thereby focusing can be performed from the infinity to the near point of a distance of 180 mm.

When the deformable mirror DM is deformed from a planar surface to a curved surface, decentering aberration is produced by reflection from a mirror surface. In particular, when focusing is carried out at the near point where amount of deformation of the deformable mirror DM appreciable, the decentering aberration is increased. In this embodiment also, like the first embodiment, to obtain favorable optical performance in the range from the far point to the near point, shift and tilt decentration is applied to a lens unit or an imaging plane. Whereby, the production of decentering aberration in focusing can be balanced.

Subsequently, numerical data of optical members constituting the optical system of the second embodiment are shown below.
Focal length: 4.9 mm (38 mm in terms of silver halide)
Open F-number: 2.8

Size of imaging plane: 4.4 mm×3.3 mm

| | Radius of | Surface | | Refractive | |
|---|---|---|---|---|---|
| Surface number | curvature | spacing | Decentration | index | Abbe's number |
| Object surface | ∞ | ∞ | | | |
| 1 | 9.778 | 0.800 | | 1.7995 | 42.2 |
| 2 | 4.275 | 1.747 | | | |
| 3 | −19.473 | 0.800 | Decentration (1) | 1.4875 | 70.2 |
| 4 | 15.434 | 5.850 | | | |
| 5 | ∞ | 0.000 | Decentration (2) | | |
| 6 | FFS [1] | 0.000 | Decentration (3) | | |
| 7 | ∞ | 4.200 | Decentration (4) | | |
| 8 (stop surface) | ∞ | 0.200 | | | |
| 9 | 6.678 | 3.729 | | 1.7433 | 49.3 |
| 10 | ASP [1] | 1.610 | | | |
| 11 | 17.604 | 2.057 | | 1.4875 | 70.2 |
| 12 | −3.861 | 0.800 | | 1.8052 | 25.4 |
| 13 | 18.669 | 2.791 | | | |
| 14 | 16.682 | 2.000 | | 1.5831 | 59.4 |
| 15 | ASP [2] | 1.179 | | | |
| 16 | ∞ | 1.000 | | 1.5163 | 64.1 |
| 17 | ∞ | 1.290 | | 1.5477 | 62.8 |
| 18 | ∞ | 0.800 | | | |
| 19 | ∞ | 0.750 | | 1.5163 | 64.1 |
| 20 | ∞ | 1.190 | | | |
| Image plane | ∞ | 0.000 | Decentration (5) | | |

Aspherical coefficients
ASP [1]

| | | |
|---|---|---|
| Radius of curvature | −17.663 | k = 0 |
| a = 6.3783 × 10⁻⁴ | b = −1.5627 × 10⁻⁵ | c = 2.2210 × 10⁻⁶ |
| d = −1.3623 × 10⁻⁷ | | |

ASP [2]

| | | |
|---|---|---|
| Radius of curvature | −15.385 | k = 0 |
| a = 5.5127 × 10⁻⁴ | b = 2.4424 × 10⁻⁵ | c = −1.9699 × 10⁻⁶ |
| d = 9.7551 × 10⁻⁸ | | |

Amount of decentration
Decentration [1] (DEO)

| | | | | |
|---|---|---|---|---|
| X = 0.000 | Y = 0.500 | Z = 0.000 | α = 0.000 | β = 0.000 |
| γ = 0.000 | | | | |

Decentration [2] (DEO)

| | | | | |
|---|---|---|---|---|
| X = 0.000 | Y = −0.476 | Z = 0.000 | α = 45.000 | β = 0.000 |
| γ = 0.000 | | | | |

Decentration [3] (DAR)

| | | | | |
|---|---|---|---|---|
| X = 0.000 | Y = 0.000 | Z (described | α = −0.484 | β = 0.000 |
| γ = 0.000 | | in FFS [1]) | | |

Decentration [4] (DEO)

| | | | | |
|---|---|---|---|---|
| X = 0.000 | Y = 0.000 | Z = 0.000 | α = 45.000 | β = 0.000 |
| γ = 0.000 | | | | |

decentration [5] (DAR)

| | | | | |
|---|---|---|---|---|
| X = 0.000 | Y = −0.057 | Z = 0.000 | α = −1.000 | β = 0.000 |
| γ = 0.000 | | | | |

FFS [1]

| | ∞ allowance | ∞ | 180 mm | 180 mm allowance |
|---|---|---|---|---|
| C4 | −0.3203 × 10⁻³ | −0.5695 × 10⁻³ | −0.9205 × 10⁻³ | −0.1143 × 10⁻² |
| C6 | −0.1610 × 10⁻³ | −0.2769 × 10⁻³ | −0.4579 × 10⁻³ | −0.5756 × 10⁻³ |
| C8 | −0.2245 × 10⁻⁴ | −0.3998 × 10⁻⁴ | −0.4782 × 10⁻⁴ | −0.5467 × 10⁻⁴ |
| C10 | −0.9427 × 10⁻⁵ | −0.1723 × 10⁻⁴ | −0.2583 × 10⁻⁴ | −0.3016 × 10⁻⁴ |
| C11 | 0.3347 × 10⁻⁵ | 0.4262 × 10⁻⁵ | 0.4300 × 10⁻⁵ | 0.3760 × 10⁻⁵ |
| C13 | −0.3381 × 10⁻⁷ | 0.1287 × 10⁻⁵ | 0.1725 × 10⁻⁵ | 0.2217 × 10⁻⁵ |
| C15 | −0.5964 × 10⁻⁷ | −0.2655 × 10⁻⁶ | −0.2504 × 10⁻⁶ | −0.4895 × 10⁻⁶ |
| Z | 0.00206 | 0.00350 | 0.00598 | 0.00803 |

TABLE 2

| | | Z1 | Z2 | Z3 | Z4 |
|---|---|---|---|---|---|
| Object distance | | ∞ allowance | ∞ | 180 mm | 180 mm allowance |
| φDMx [l/mm] | | −3.203E−04 | −5.695E−04 | −9.205E−04 | −1.143E−03 |
| φDMy [l/mm] | | −1.610E−04 | −2.769E−04 | −4.579E−04 | −5.756E−04 |
| md [mm] | | 2.060E−03 | 3.500E−03 | 5.980E−03 | 8.030E−03 |
| β1 | Condition 7 | −0.817 | −0.817 | −0.818 | −0.817 |
| fl [mm] | | 4.956 | 4.954 | 4.958 | 4.952 |
| Cj [mm] | | 32.790 | 32.790 | 32.790 | 32.790 |
| Sm [mm²] | | 27.155 | 27.155 | 27.155 | 27.155 |
| f 1 [mm] | | −6.063 | −6.063 | −6.063 | −6.063 |
| δ [mm] | | 0.500 | 0.500 | 0.500 | 0.500 |
| ε [deg] | Condition 10 | −1.000 | −1.000 | −1.000 | −1.000 |
| \|md/fl\| | Condition 1 | 4.156E−04 | 7.065E−04 | 1.206E−03 | 1.621E−03 |
| md²/Sm | Condition 2 | 1.563E−07 | 4.511E−07 | 1.317E−06 | 2.375E−06 |
| \|φDM × fl\| | Condition 4 | 1.193E−03 | 2.097E−03 | 3.417E−03 | 4.255E−03 |
| f 1/fl | Condition 5 | −1.223 | −1.224 | −1.223 | −1.224 |
| Cj/fl | Condition 8 | 6.616 | 6.619 | 6.614 | 6.621 |
| \|δ/fl\| | Condition 9 | 0.101 | 0.101 | 0.101 | 0.101 |

Third Embodiment

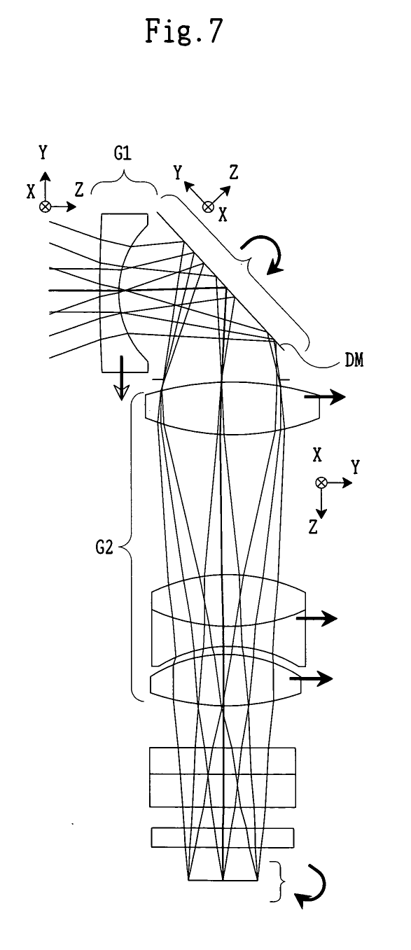

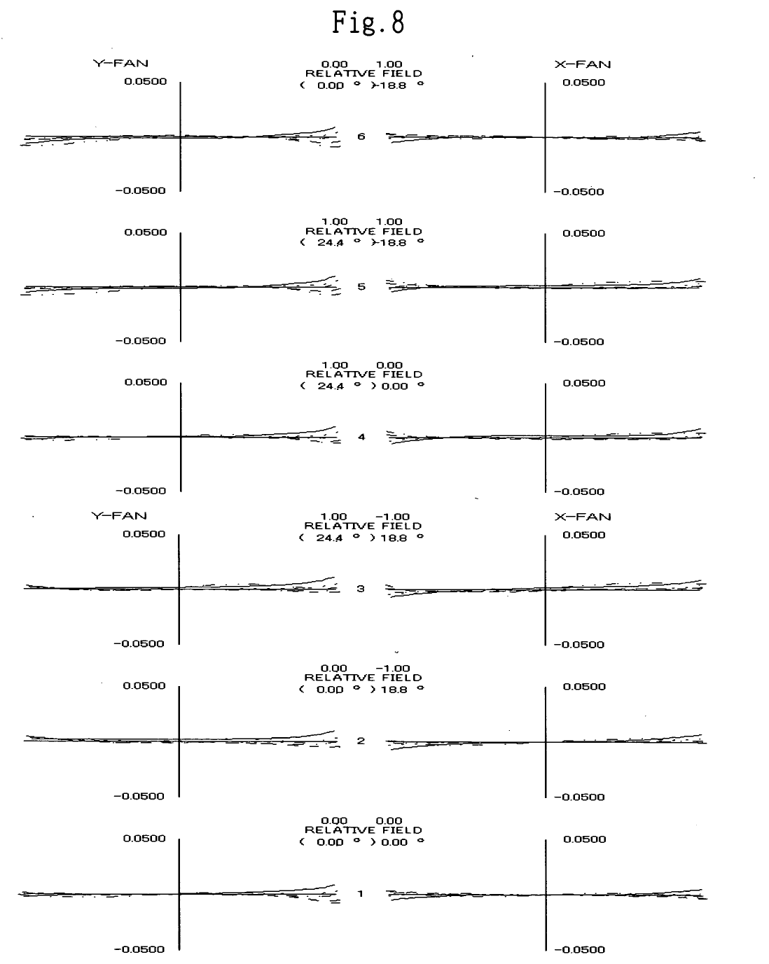

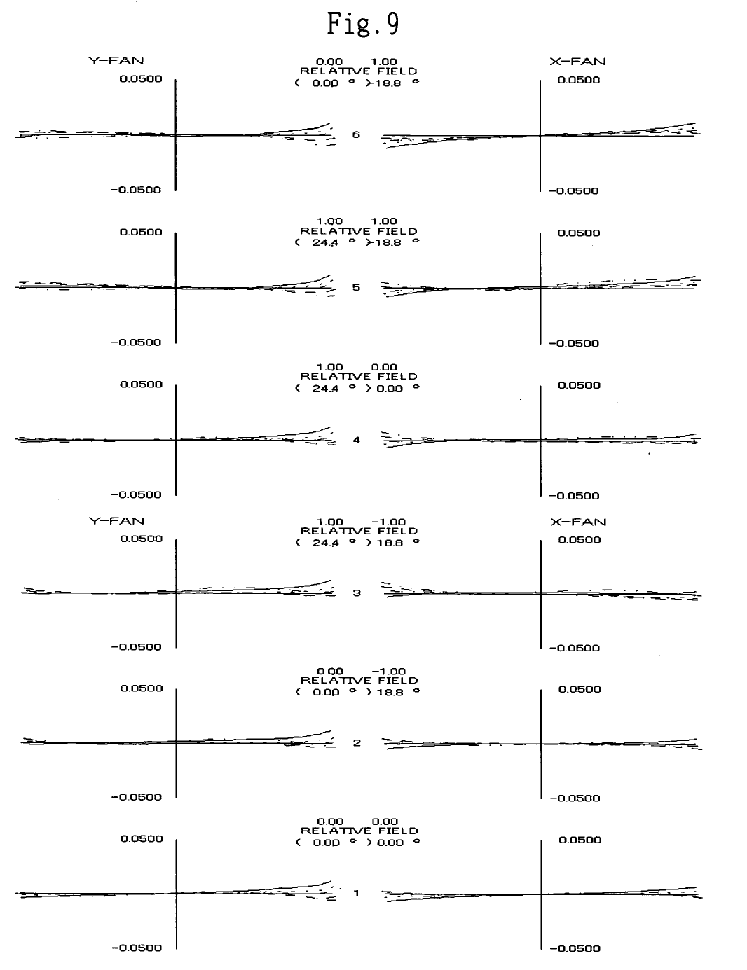

FIG. 7 shows the optical system of the third embodiment in the present invention. FIG. 8 shows transverse aberrations at infinity of an object point distance in the third embodiment. FIG. 9 shows transverse aberrations at an object point distance of 150 mm in the third embodiment. Also, in FIG. 7, each of arrows indicates the direction of decentration of an optical member.

The optical system of the third embodiment, as shown in FIG. 7, includes a deformable mirror DM; a concave lens unit G1 with one lens component composed of one lens element, located on the object side of the deformable mirror DM; and a convex lens unit G2 with three lens components composed of four lens elements, located on the image side of the deformable mirror DM. The deformable mirror DM is deformed and thereby focusing can be performed from the infinity to the near point of a distance of 150 mm.

When the deformable mirror DM is deformed from a planar surface to a curved surface, decentering aberration is produced by reflection from a mirror surface. In particular, when focusing is carried out at the near point where the amount of deformation of the deformable mirror DM is appreciable, the decentering aberration is increased. In this embodiment, like the first or second embodiment, to obtain favorable optical performance in the range from the far point to the near point, shift and tilt decentration is applied to a lens unit or an imaging plane. Whereby, the production of decentering aberration in focusing can be balanced.

Subsequently, numerical data of optical members constituting the optical system of the third embodiment are shown below.
Focal length: 4.4 mm (38 mm in terms of silver halide)
Open F-number: 2.8

Size of imaging plane: 4.0 mm×3.0 mm

| | Radius of | Surface | | Refractive | |
|---|---|---|---|---|---|
| Surface number | curvature | spacing | Decentration | index | Abbe's number |
| Object surface | ∞ | ∞ | | | |
| 1 | ASP [1] | 0.800 | Decentration (1) | 1.8141 | 32.2 |
| 2 | ASP [2] | 4.200 | Decentration (1) | | |
| 3 | ∞ | 0.000 | Decentration (2) | | |
| 4 | FFS [1] | 0.000 | Decentration (3) | | |
| 5 | ∞ | 3.800 | Decentration (4) | | |
| 6 (stop surface) | ∞ | 0.100 | | | |
| 7 | ASP [3] | 2.000 | Decentration (5) | 1.7465 | 51.1 |
| 8 | ASP [4] | 5.438 | Decentration (5) | | |
| 9 | 7.324 | 2.021 | Decentration (6) | 1.5011 | 68.3 |
| 10 | −7.973 | 0.800 | Decentration (6) | 1.8307 | 24.5 |
| 11 | 5.885 | 0.300 | Decentration (6) | | |
| 12 | 5.787 | 2.000 | Decentration (7) | 1.4900 | 70.0 |
| 13 | ASP [5] | 1.626 | Decentration (7) | | |
| 14 | ∞ | 1.000 | | 1.5163 | 64.1 |
| 15 | ∞ | 1.290 | | 1.5477 | 62.8 |
| 16 | ∞ | 0.800 | | | |
| 17 | ∞ | 0.750 | | 1.5163 | 64.1 |
| 18 | ∞ | 1.200 | | | |
| Image plane | ∞ | 0.000 | Decentration (8) | | |

Aspherical coefficients
ASP [1]

| | | |
|---|---|---|
| Radius of curvature | 70.428 | k = 0 |
| a = 2.2133 × 10⁻³ | b = −4.1162 × 10⁻⁴ | c = 2.4537 × 10⁻⁵ |
| d = −3.6373 × 10⁻⁷ | | |

ASP [2]

| | | |
|---|---|---|
| Radius of curvature | 3.507 | k = 0 |
| a = 2.1789 × 10⁻³ | b = −4.6380 × 10⁻⁴ | c = −3.9638 × 10⁻⁵ |
| d = 5.3918 × 10⁻⁶ | | |

ASP [3]

| | | |
|---|---|---|
| Radius of curvature | 13.911 | k = 0 |
| a = 5.4052 × 10⁻⁵ | b = −2.3064 × 10⁻⁶ | c = 1.0798 × 10⁻⁶ |
| d = 3.3961 × 10⁻⁸ | | |

ASP [4]

| | | |
|---|---|---|
| Radius of curvature | −9.140 | k = 0 |
| a = 3.7861 × 10⁻⁴ | b = 6.5188 × 10⁻⁶ | c = −8.0902 × 10⁻⁸ |
| d = 9.8151 × 10⁻⁸ | | |

ASP [5]

| | | |
|---|---|---|
| Radius of curvature | −8.610 | k = 0 |
| a = 1.3105 × 10⁻³ | b = −2.6285 × 10⁻⁵ | c = 2.0896 × 10⁻⁶ |
| d = −9.3284 × 10⁻⁸ | | |

Amount of decentration
Decentration [1] (DAR)

| | | | | |
|---|---|---|---|---|
| X = 0.000 | Y = −0.455 | Z = 0.000 | α = 0.000 | β = 0.000 |
| γ = 0.000 | | | | |

Decentration [2] (DEO)

| | | | | |
|---|---|---|---|---|
| X = 0.000 | Y = 0.000 | Z = 0.000 | α = 45.000 | β = 0.000 |
| γ = 0.000 | | | | |

Decentration [3] (DAR)

| | | | | |
|---|---|---|---|---|
| X = 0.000 | Y (described | Z (described | α = −0.783 | β = 0.000 |
| γ = 0.000 | in FFS [1]) | in FFS [1]) | | |

Decentration [4] (DEO)

| | | | | |
|---|---|---|---|---|
| X = 0.000 | Y = 0.000 | Z = 0.000 | α = 45.000 | β = 0.000 |
| γ = 0.000 | | | | |

Decentration [5] (DAR)

| | | | | |
|---|---|---|---|---|
| X = 0.000 | Y = 0.428 | Z = 0.000 | α = 0.000 | β = 0.000 |
| γ = 0.000 | | | | |

Decentration [6] (DAR)

| | | | | |
|---|---|---|---|---|
| X = 0.000 | Y = 0.270 | Z = 0.000 | α = 0.000 | β = 0.000 |
| γ = 0.000 | | | | |

Decentration [7] (DAR)

| | | | | |
|---|---|---|---|---|
| X = 0.000 | Y = 0.147 | Z = 0.000 | α = 0.000 | β = 0.000 |
| γ = 0.000 | | | | |

Decentration [8] (DAR)

| | | | | |
|---|---|---|---|---|
| X = 0.000 | Y = 0.000 | Z = 0.000 | α = −2.000 | β = 0.000 |
| γ = 0.000 | | | | |

FFS [1]

| | ∞ allowance | ∞ | 150 mm | 150 mm allowance |
|---|---|---|---|---|
| C4 | 0.00000 | −0.5892 × 10⁻³ | −0.1086 × 10⁻² | −0.1575 × 10⁻² |
| C6 | 0.00000 | −0.3128 × 10⁻³ | −0.6189 × 10⁻³ | −0.9311 × 10⁻³ |
| C8 | 0.00000 | −0.3938 × 10⁻⁴ | −0.6338 × 10⁻⁴ | −0.9810 × 10⁻⁴ |
| C10 | 0.00000 | −0.2812 × 10⁻⁴ | −0.4815 × 10⁻⁴ | −0.7349 × 10⁻⁴ |
| C11 | 0.00000 | 0.2639 × 10⁻⁵ | 0.3921 × 10⁻⁵ | 0.5562 × 10⁻⁶ |
| C13 | 0.00000 | −0.2463 × 10⁻⁵ | 0.6584 × 10⁻⁶ | −0.2496 × 10⁻⁵ |
| C15 | 0.00000 | −0.2641 × 10⁻⁵ | −0.2915 × 10⁻⁵ | −0.4413 × 10⁻⁵ |
| Y | 0.00000 | 0.47001 | 0.34044 | 0.36255 |
| Z | 0.00000 | 0.00338 | 0.00643 | 0.00964 |

TABLE 3

| | | Z1 | Z2 | Z3 | Z4 |
|---|---|---|---|---|---|
| Object distance | | ∞ allowance | ∞ | 150 mm | 150 mm allowance |
| φDMx [l/mm] | | 0.000E+00 | −5.892E−04 | −1.086E−03 | −1.575E−03 |
| φDMy [l/mm] | | 0.000E+00 | −3.128E−04 | −6.189E−04 | −9.311E−04 |
| md [mm] | | 0.000E+00 | 3.380E−03 | 6.430E−03 | 9.640E−03 |
| β1 | Condition 7 | −0.995 | −0.995 | −0.994 | −0.993 |
| fl [mm] | | 4.538 | 4.538 | 4.538 | 4.538 |
| Cj [mm] | | 28.250 | 28.250 | 28.250 | 28.250 |
| Sm [mm²] | | 25.525 | 25.525 | 25.525 | 25.525 |
| f 1 [mm] | | −4.558 | −4.558 | −4.558 | −4.558 |
| δ [mm] | | 0.455 | 0.455 | 0.455 | 0.455 |
| ε [deg] | Condition 10 | −2.000 | −2.000 | −2.000 | −2.000 |
| \|md/fl\| | Condition 1 | 0.000E+00 | 7.448E−04 | 1.417E−03 | 2.124E−03 |
| md²/Sm | Condition 2 | 0.000E+00 | 4.476E−07 | 1.620E−06 | 3.641E−06 |
| \|φDM × fl\| | Condition 4 | 0.000E+00 | 2.047E−03 | 3.868E−03 | 5.686E−03 |
| f 1/fl | Condition 5 | −1.004 | −1.004 | −1.004 | −1.004 |
| Cj/fl | Condition 8 | 6.225 | 6.225 | 6.225 | 6.225 |
| \|δ/fl\| | Condition 9 | 0.100 | 0.100 | 0.100 | 0.100 |

In each of the above embodiments, reference has been made to the optical system using the deformable mirror. However, even when the optical system uses a planar mirror or a curved mirror, the shape of which remains unchanged, instead of the deformable mirror, the above conditions and limitations may be applied, unless otherwise specified. This is because the merit of compactness in a path-bending optical system using the mirror is kept as it is.

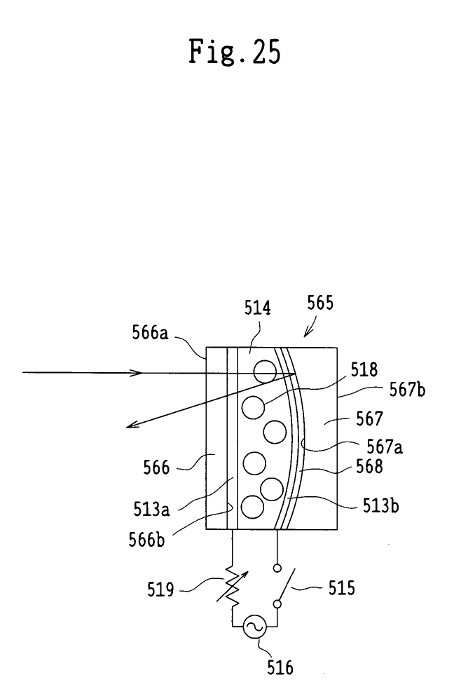

In each embodiment, the optical system that has a reflecting surface in a lens unit has also been described. However, when an optical system that has no reflecting surface is designed to use an optical element provided with a deformable surface, for example, a variable focal-length lens, the effects of compactness, low cost, saving power, and noiselessness of operation can be brought about. In addition, a variable focal-length mirror that has no deformable surface may be used in each embodiment mentioned above. The variable focal-length mirror will be described later with reference to FIG. 25 as an example.

The optical system according to the present invention is applicable to a film camera, a digital camera, a TV camera, a camera for personal digital assistants, a monitoring camera, a robot's eye, and an electronic endoscope.

Also, although in the above description an imaging optical system is assumed as the optical system, it can be used as a projection optical system, such as a projector, by replacing the object surface with the image plane.

Subsequently, a description is given of the structural examples of deformable mirrors applicable to the optical system of the present invention and the optical apparatus using the optical system.

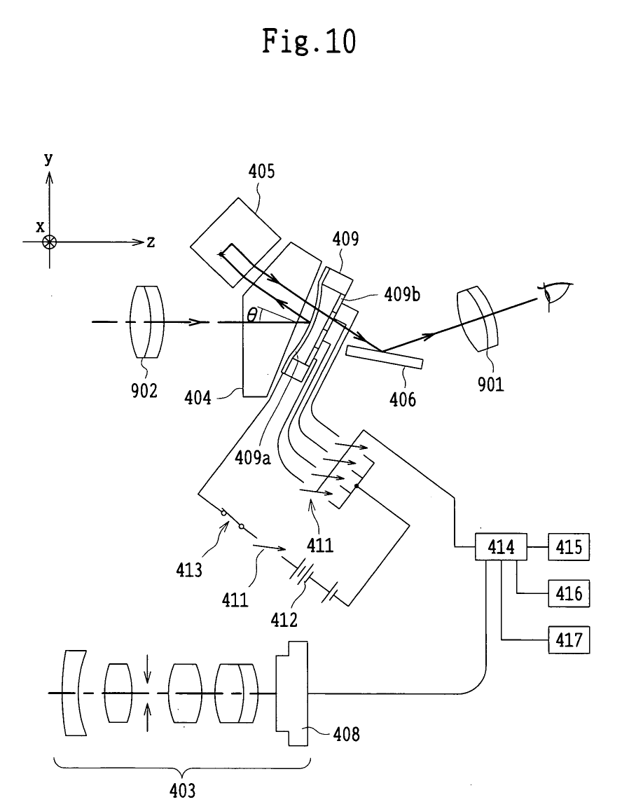

FIG. 10 shows a Keplerian finder for a digital camera using a variable optical-property mirror as a variable mirror applicable to the optical system of the present invention. It can, of course, be used for a silver halide film camera. Reference is first made to a variable optical-property mirror 409.

The variable optical-property mirror 409 refers to a variable optical-property deformable mirror (which is hereinafter simply called a deformable mirror) including a thin film (reflecting surface) 409a coated with aluminum and a plurality of electrodes 409b. Reference numeral 411 denotes a plurality of variable resistors connected to the electrodes 409b; 412 denotes a power supply connected between the thin film 409a and the electrodes 409b through the variable resistors 411 and a power switch 413; 414 denotes an arithmetical unit for controlling the resistance values of the plurality of variable resistors 411; and 415, 416, and 417 denote a temperature sensor, a humidity sensor, and a range sensor, respectively, connected to the arithmetical unit 414, which are arranged as shown in the figure to constitute one optical apparatus.

Each of the surfaces of an objective lens 902, an eyepiece 901, a prism 404, an isosceles rectangular prism 405, a mirror 406, and the deformable mirror 409 need not necessarily be planar, and may have any shape such as a spherical or rotationally symmetrical aspherical surface; a spherical, planar, or rotationally symmetrical aspherical surface which has decentration with respect to the optical axis; an aspherical surface with symmetrical surfaces; an aspherical surface with only one symmetrical surface; an aspherical surface with no symmetrical surface; a free-formed surface; a surface with a nondifferentiable point or line; etc. Moreover, any surface which has some effect on light, such as a reflecting or refracting surface, is satisfactory. In general, such a surface is hereinafter referred as to an extended surface.

The thin film 409a, like a membrane mirror set forth, for example, in “Handbook of Microlithography, Micromachining and Microfabrication”, by P. RaiChoudhury, Volume 2: Micromachining and Microfabrication, p. 495, FIG. 8.58, SPIE PRESS, or Optics Communication, Vol. 140, pp. 187-190, 1997, is such that when voltages are applied between the thin film 409a and the plurality of electrodes, the thin film 409a is deformed by the electrostatic force and its surface profile is changed. Whereby, not only can focusing be adjusted to the diopter of an observer, but it is also possible to suppress deformations and changes of refractive indices, caused by temperature and humidity changes of the lenses 902 and 901 and/or the prism 404, the isosceles rectangular prism 405, and the mirror 406, or the degradation of imaging performance by the expansion and deformation of a lens frame and assembly errors of parts, such as optical elements and frames. In this way, a focusing adjustment and correction for aberration produced by the focusing adjustment can be always properly made. Also, it is only necessary that the profile of the electrodes 409b, for example, as shown in FIG. 12 or 13, is selected in accordance with the deformation of the thin film 409a.

According to this example, light from an object is refracted by the entrance and exit surfaces of the objective lens 902 and the prism 404, and after being reflected by the deformable mirror 409, is transmitted through the prism 404. The light is further reflected by the isosceles rectangular prism 405 (in FIG. 10, a mark+on the optical path indicates that a ray of light travels toward the back side of the plane of the page), and is reflected by the mirror 406 to enter the eye through the eyepiece 901. As mentioned above, the lenses 901 and 902, the prisms 404 and 405, and the deformable mirror 409 constitute the observation optical system of the optical apparatus of the present invention. The surface profile and thickness of each of these optical elements are optimized and thereby aberration of an object surface can be minimized.

Specifically, the configuration of the thin film 409a functioning as the reflecting surface is controlled in such a way that the resistance values of the variable resistors 411 are changed by signals from the arithmetical unit 414 to optimize imaging performance. Signals corresponding to ambient temperature and humidity and a distance to the object are input into the arithmetical unit 414 from the temperature sensor 415, the humidity sensor 416, and the range sensor 417. In order to compensate for the degradation of imaging performance due to the ambient temperature and humidity and the distance to the object in accordance with these input signals, the arithmetical unit 414 outputs signals for determining the resistance values of the variable resistors 411 so that voltages by which the configuration of the thin film 409a is determined are applied to the electrodes 409b. Thus, since the thin film 409a is deformed with the voltages applied to the electrodes 409b, that is, the electrostatic forces, it assumes various shapes including an aspherical surface, according to circumstances.

The range sensor 417 need not necessarily be used, and in this case, it is only necessary that an imaging lens 403 of the digital camera is moved so that a high-frequency component of an image signal from a solid-state image sensor 408 is roughly maximized, and the object distance is calculated from this position so that an observer's eye is able to focus upon the object image by deforming the deformable mirror.

When the thin film 409a is made of synthetic resin, such as polyimide, it can be considerably deformed even at a low voltage, which is advantageous. Also, the prism 404 and the deformable mirror 409 can be integrally configured into a unit. Also, although not shown in the figure, the solid-state image sensor 408 may be constructed integrally with the substrate of the deformable mirror 409 by a lithography process.

When each of the lenses 901 and 902, the prisms 404 and 405, and the mirror 406 is configured by a plastic mold, an arbitrary curved surface of a desired configuration can be easily obtained and its fabrication is simple. In the imaging apparatus of this example, the lenses 902 and 901 are arranged separately from the prism 404. However, if the prisms 404 and 405, the mirror 406, and the deformable mirror 409 are designed so that aberration can be eliminated without providing the lenses 902 and 901, the prisms 404 and 405 and the deformable mirror 409 will be configured as one optical block, and the assembly is facilitated. Parts or all of the lenses 902 and 901, the prisms 404 and 405, and the mirror 406 may be made of glass. By doing so, an observation optical system with a higher degree of accuracy is obtained.

Also, although in FIG. 10 the arithmetical unit 414, the temperature sensor 415, the humidity sensor 416, and the range sensor 417 are provided so that the deformable mirror 409 compensates for the changes of the temperature, the humidity, and the object distance, the present invention is not limited to this construction. That is, the arithmetical unit 414, the temperature sensor 415, the humidity sensor 416, and the range sensor 417 may be eliminated so that the deformable mirror 409 compensates for only a change of an observer's diopter.

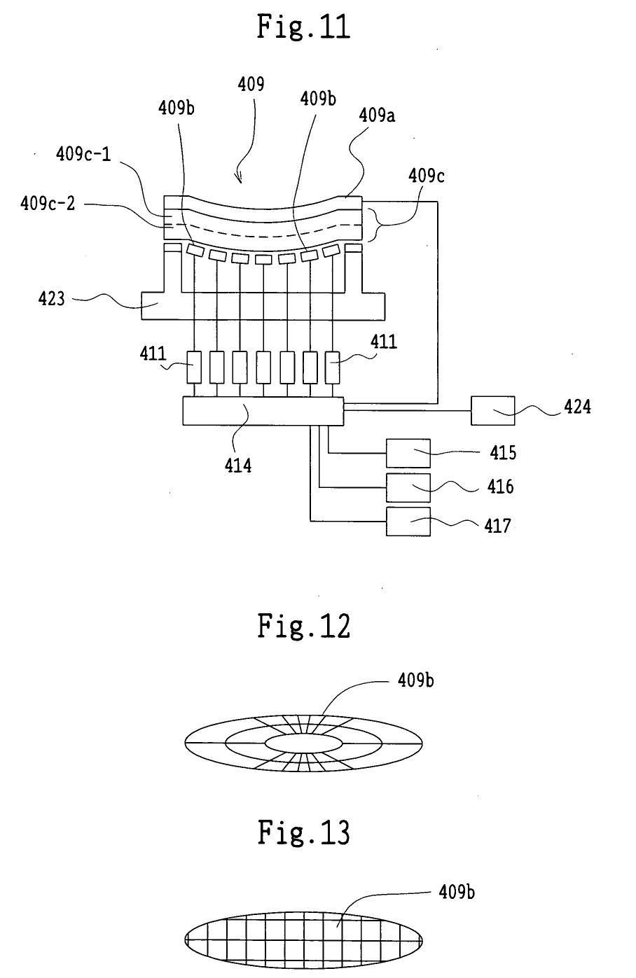

FIG. 11 shows another example of the deformable mirror 409 applicable as the variable mirror used in the optical system of the present invention.

In the deformable mirror of this example, a piezoelectric element 409c is interposed between the thin film 409a and the electrodes 409b, and these are placed on a support 423. A voltage applied to the piezoelectric element 409c is changed in accordance with each of the electrodes 409b, and thereby the piezoelectric element 409c causes expansion and contraction which are partially different so that the shape of the thin film 409a can be changed. The configuration of the electrodes 409b, illustrated in FIG. 12, may have a concentric division pattern, or as in FIG. 13, may be a rectangular division pattern. As other patterns, proper configurations can be chosen.

In FIG. 11, reference numeral 424 represents a shake sensor connected to the arithmetical unit 414. The shake sensor 424, for example, detects the shake of a digital camera and changes the voltages applied to the electrodes 409b through the arithmetical unit 414 and the variable resistors 411 in order to deform the thin film 409a so as to compensate for the blurring of an image caused by the shake. At this time, signals from the temperature sensor 415, the humidity sensor 416, and range sensor 417 are taken into account simultaneously, and focusing and compensation for temperature and humidity are performed. In this case, stress is applied to the thin film 409a by the deformation of the piezoelectric element 409c, and hence it is good practice to design the thin film 409a so that it has a moderate thickness and a proper strength.

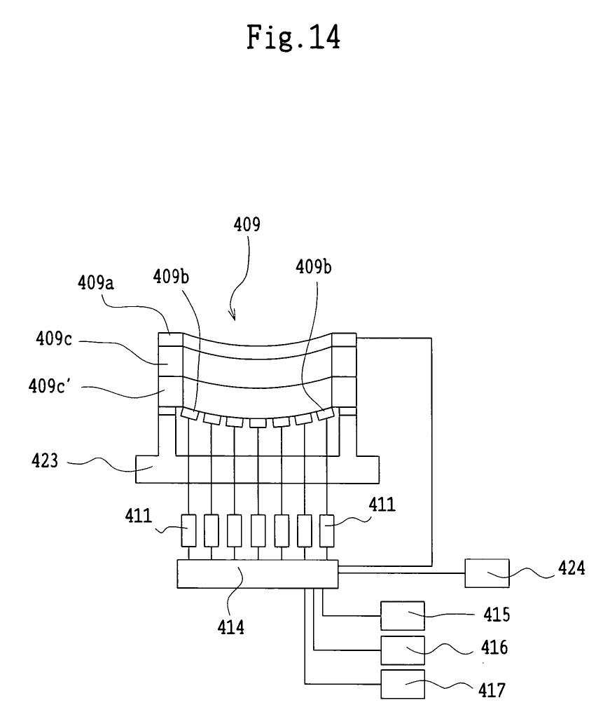

FIG. 14 shows still another example of the deformable mirror 409 applicable as the variable mirror used in the optical system of the present invention.

This example has the same construction as the deformable mirror of FIG. 11 with the exception that two piezoelectric elements 409c and 409c′ are interposed between the thin film 409a and the electrodes 409b and are made with substances having piezoelectric characteristics which are reversed in direction. Specifically, when the piezoelectric elements 409c and 409c′ are made with ferroelectric crystals, they are arranged so that their crystal axes are reversed in direction with respect to each other.

In this case, the piezoelectric elements 409c and 409c′ expand or contract in reverse directions when voltages are applied, and thus there is the advantage that a force for deforming the thin film 409a becomes stronger than in the example of FIG. 11, and as a result, the shape of the mirror surface can be considerably changed.

For substances used for the piezoelectric elements 409c and 409c′, for example, there are piezoelectric substances such as barium titanate, Rochelle salt, crystal, tourmaline, KDP, ADP, and lithium niobate; polycrystals or crystals of the piezoelectric substances; piezoelectric ceramics such as solid solutions of PbZrO₃ and PbTiO₃; organic piezoelectric substances such as PVDF; and other ferroelectrics. In particular, the organic piezoelectric substance has a small value of Young's modulus and brings about a considerable deformation at a low voltage, which is favorable. When these piezoelectric elements are used, it is also possible to properly deform the thin film 409a in each of the above examples if their thicknesses are made uneven.

As materials of the piezoelectric elements 409c and 409c′, high-polymer piezoelectrics such as polyurethane, silicon rubber, acrylic elastomer, PZT, PLZT, and PVDF; vinylidene cyanide copolymer; and copolymer of vinylidene fluoride and trifluoroethylene are used. The use of an organic substance, synthetic resin, or elastomer, having a piezoelectric property, brings about a considerable deformation of the surface of the deformable mirror, which is favorable.

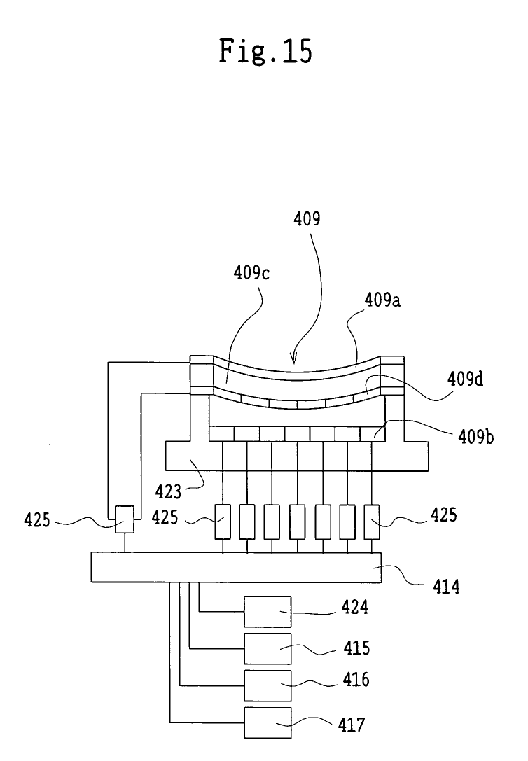

When an electrostrictive substance, for example, acrylic elastomer or silicon rubber, is used for the piezoelectric element 409c shown in FIGS. 11 and 15, the piezoelectric element 409c, as indicated by a broken line in FIG. 11, may have the two-layer structure in which a substrate 409c-1 is cemented to an electrostrictive substance 409c-2.

FIG. 15 shows another example of the deformable mirror 409 applicable as the variable mirror used in the optical system of the present invention.

The deformable mirror of this example is designed so that the piezoelectric element 409c is sandwiched between the thin film 409a and a plurality of electrodes 409d, and these are placed on the support 423. Voltages are applied to the piezoelectric element 409c between the thin film 409a and the electrodes 409d through a driving circuit 425 controlled by the arithmetical unit 414. Furthermore, apart from this, voltages are also applied to the plurality of electrodes 409b provided on a bottom surface inside the support 423, through driving circuits 425 controlled by the arithmetical unit 414. Therefore, the thin film 409a can be doubly deformed by electrostatic forces due to the voltages applied between the thin film 409a and the electrodes 409d and applied to the electrodes 409b. There are advantages that various deformation patterns can be provided and the response is quick, compared with any of the above examples.

By changing the signs of the voltages applied between the thin film 409a and the electrodes 409d, the thin film 409a of the deformable mirror 409 can be deformed into either a convex or concave surface. In this case, a considerable deformation may be performed by a piezoelectric effect, while a slight shape change may be carried out by the electrostatic force. Alternatively, the piezoelectric effect may be chiefly used for the deformation of the convex surface, while the electrostatic force may be used for the deformation of the concave surface. Also, the electrodes 409d may be constructed as a plurality of electrodes like the electrodes 409b. The condition of electrodes 409d constructed as the plurality of electrodes is shown in FIG. 15. In the description, all of the piezoelectric effect, the electrostrictive effect, and electrostriction are generally called the piezoelectric effect. Thus, it is assumed that the electrostrictive substance is included in the piezoelectric substance.

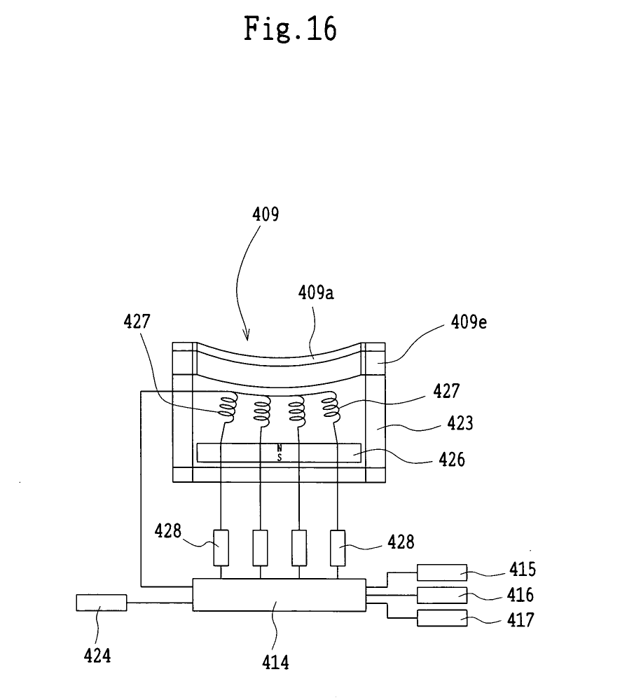

FIG. 16 shows another example of the deformable mirror 409 applicable as the variable mirror used in the optical system of the present invention. The deformable mirror 409 of this example is designed so that the shape of the reflecting surface can be changed by utilizing an electromagnetic force. A permanent magnet 426 is fixed on the bottom surface inside the support 423, and the periphery of a substrate 409e made with silicon nitride or polyimide is mounted and fixed on the top surface thereof. The thin film 409a with the coating of metal, such as aluminum, is deposited on the surface of the substrate 409e, thereby constituting the deformable mirror 409.

Below the substrate 409e, a plurality of coils 427 are fixedly mounted and connected to the arithmetical unit 414 through driving circuits 428. In accordance with output signals from the arithmetical unit 414 corresponding to changes of the optical system obtained at the arithmetical unit 414 by signals from the sensor 415, 416, 417, and 424, proper electric currents are supplied from the driving circuits 428 to the coils 427. At this time, the coils 427 are repelled or attracted by the electromagnetic force with the permanent magnet 426 to deform the substrate 409e and the thin film 409a.

In this case, a different amount of current can also be caused to flow through each of the coils 427. A single coil 427 may be used. The permanent magnet 426 may be mounted on the lower surface of the substrate 409e so that the coils 427 are arranged on the bottom surface inside the support 423. It is desirable that the coils 427 are made by a lithography process. A ferromagnetic iron core may be encased in each of the coils 427.

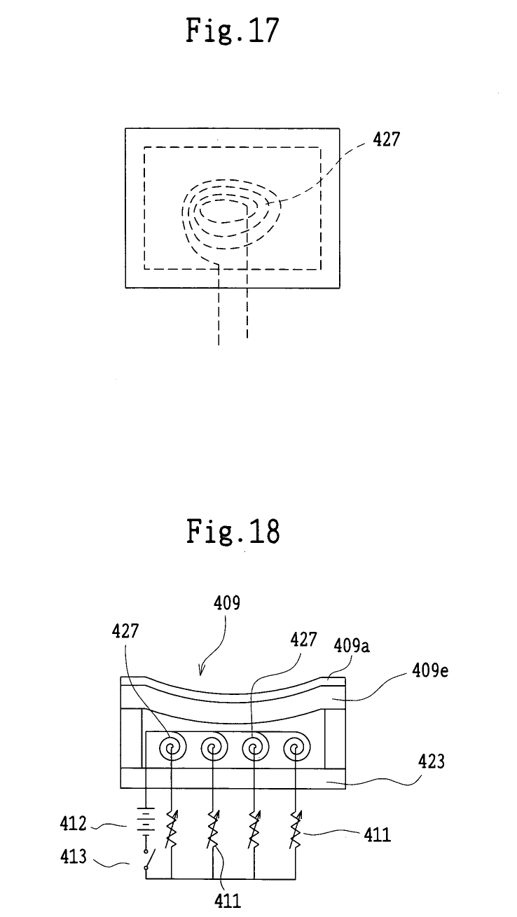

In this case, each of the coils 427, as illustrated in FIG. 17, can be designed so that a coil density varies with the place, and thereby a desired deformation is brought to the substrate 409e and the thin film 409a. A single coil 427 may be used, or a ferromagnetic iron core may be encased in each of the coils 427.

FIG. 18 shows another example of the deformable mirror 409 applicable as the variable mirror used in the optical system of the present invention.

In the deformable mirror 409 of this example, the substrate 409e is made with a ferromagnetic such as iron, and the thin film 409a as a reflecting film is made with aluminum. In this case, since the thin film coils need not be provided beneath the substrate 409e, the structure is simple and the manufacturing cost can be reduced. If the power switch 413 is replaced with a changeover and power on-off switch, the directions of currents flowing through the coils 427 can be changed, and the configurations of the substrate 409e and the thin film 409a can be changed at will.

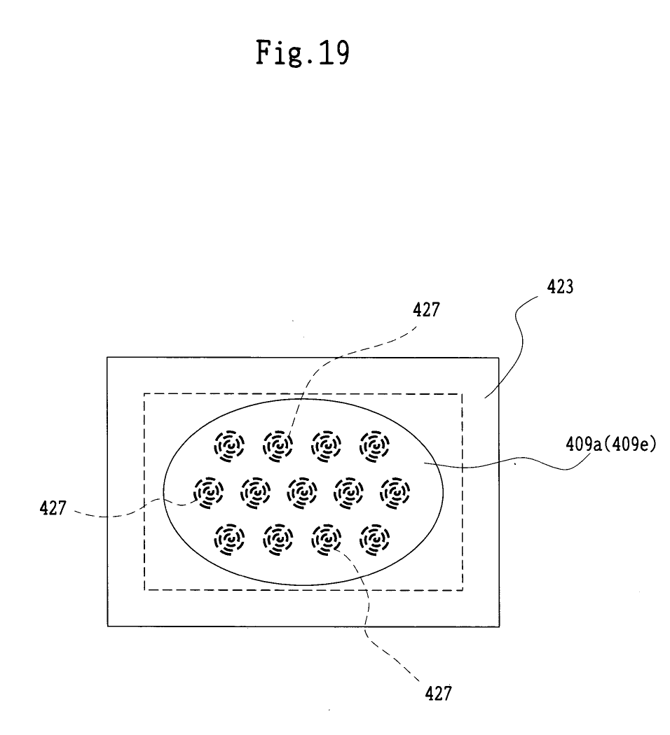

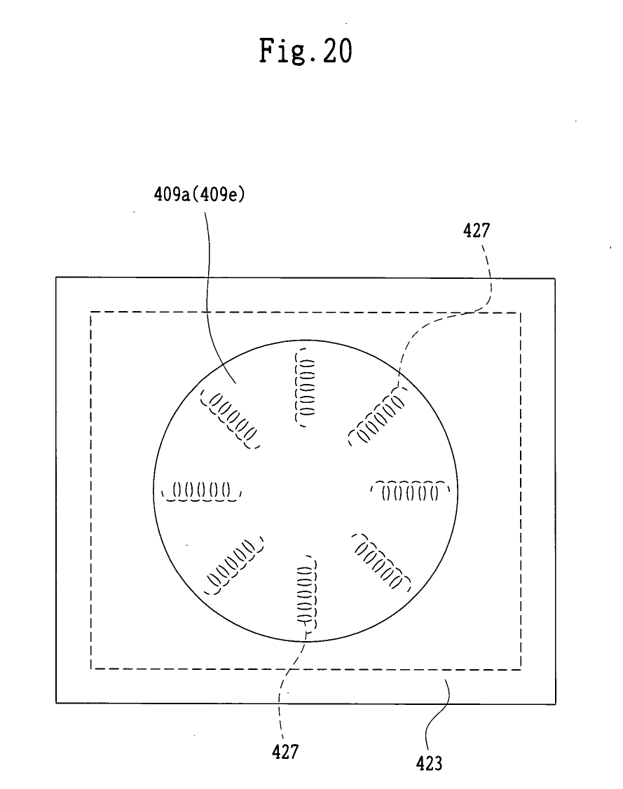

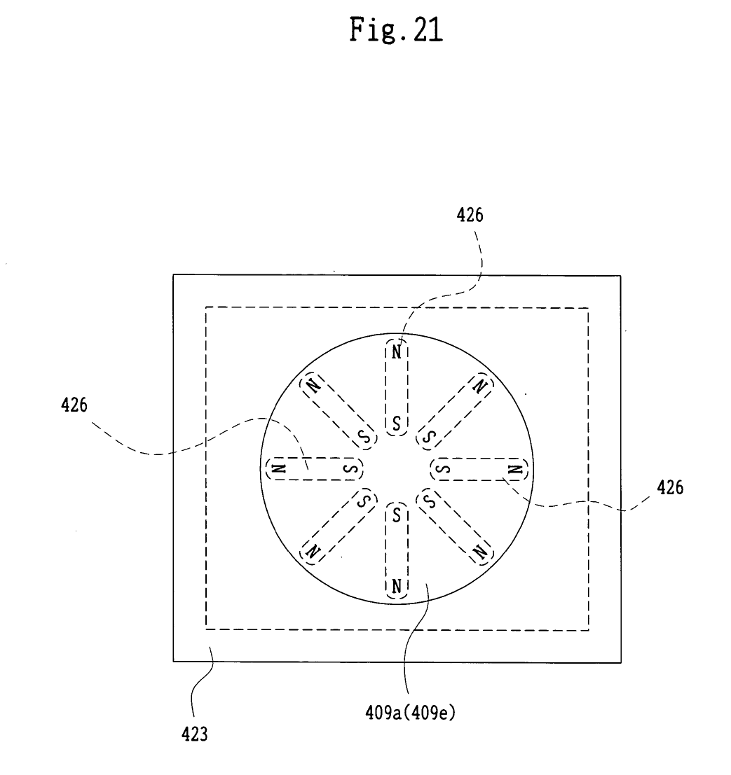

FIG. 19 shows an example of an array of the coils 427. FIG. 20 shows another example of the array of the coils 427. These arrays are also applicable to the example of FIG. 16. FIG. 21 shows an array of the permanent magnets 426 suitable for the case where the coils 427 are arrayed as in FIG. 20, in the example of FIG. 16. Specifically, when the permanent magnets 426, as shown in FIG. 21, are radially arrayed, a delicate deformation can be provided to each of the substrate 409e and the thin film 409a in contrast with the example of FIG. 16. As mentioned above, when the electromagnetic force is used to deform the substrate 409e and the thin film 409a (in the examples of FIGS. 16 and 18), there is the advantage that they can be driven at a lower voltage than in the case where the electrostatic force is used.

Some examples of the deformable mirrors have been described, but as shown in the example of FIG. 15, at least two kinds of forces may be used in order to change the shape of the mirror. Specifically, at least two of the electrostatic force, electromagnetic force, piezoelectric effect, magnetrostriction, pressure of a fluid, electric field, magnetic field, temperature change, and electromagnetic wave, may be used simultaneously to deform the deformable mirror. That is, when at least two different driving techniques are used to make the variable optical-property element, a considerable deformation and a slight deformation can be realized simultaneously and a mirror surface with a high degree of accuracy can be obtained.

It is desirable that the contour of the portion that the deformable mirror is deformed is long along the direction parallel to the surface on which an axial ray is incident. By doing so, there is the advantage that the mirror is easily changed into a shape approaching to an elliptical surface that is favorable for correction for aberration. For the contour that is long along the direction parallel to the surface, a track shape, polygon, or ellipse is used.

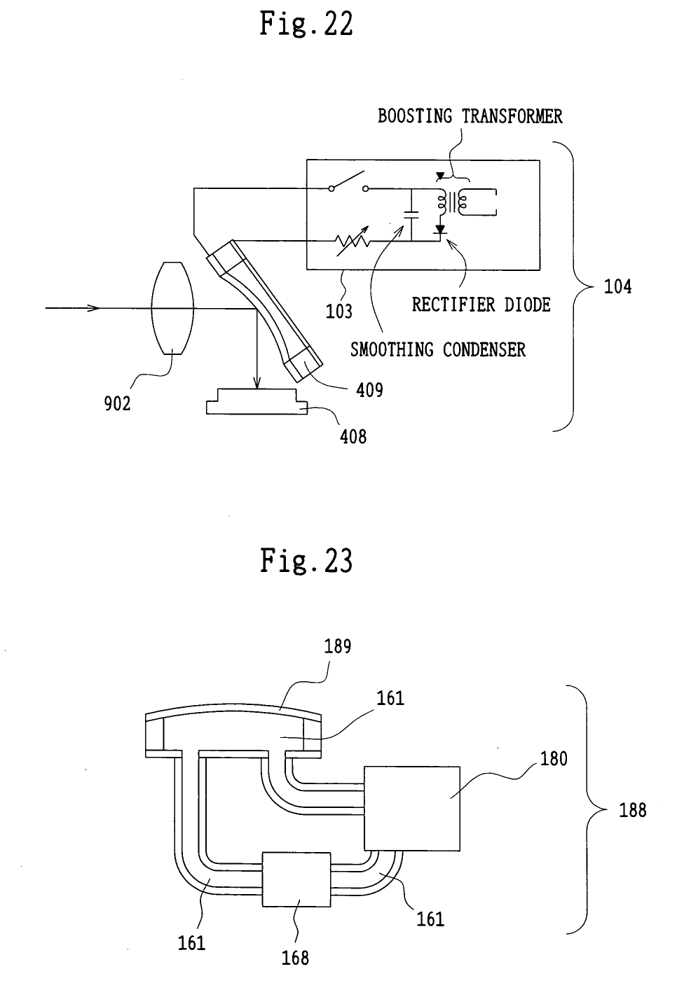

FIG. 22 shows an imaging system which uses the deformable mirror 409 as the variable mirror applicable to an imaging apparatus using the optical system of the present invention and is used, for example, in a digital camera of a mobile phone, a capsule endoscope, an electronic endoscope, a digital camera for personal computers, or a digital camera for PDAs.

In the imaging system of this example, one imaging unit 104 is constructed with the deformable mirror 409, the lens 902, the solid-state image sensor 408, and a control system 103. The imaging unit 104 of this example is designed so that light from an object passing through the lens 902 is condensed by the deformable mirror 409, and is imaged on the solid-state image sensor 408. An image signal obtained by the solid-state image sensor 408 is processed by an electronic circuit and an image can be displayed on a display device. Moreover, image information can be stored in a recording device. The deformable mirror 409 is a kind of variable optical-property element and is also referred to as a variable focal-length mirror.

According to this example, even when the object distance is changed, the deformable mirror 409 is deformed and thereby the object can be brought into a focus. The example need not move the lens 902 by using a motor and excels in compact and lightweight design and low power consumption. The imaging unit 104 can be used in any of the examples as the imaging system of the present invention. When a plurality of deformable mirrors 409 are used, an optical system, such as a zoom imaging system or a variable magnification imaging system, can be constructed.

In FIG. 22, an example of a control system is cited which includes the boosting circuit of a transformer using coils in the control system 103. When a laminated piezoelectric transformer is particularly used, a compact design is achieved. The boosting circuit can be used in the deformable mirror or the variable focal-length lens of the present invention which uses electricity, and is useful in particular for the deformable mirror or the variable focal-length lens which utilizes the electrostatic force or the piezoelectric effect.

FIG. 23 shows another example applicable as the variable mirror used in the optical system of the present invention, that is, a deformable mirror 188 constructed so that a fluid 161 is taken in and out by a micropump 180 to deform a mirror surface. According to this example, there is the merit that the mirror surface can be considerably deformed. The micropump 180 is a small-sized pump, for example, made by a micromachining technique and is constructed so that it is operated with an electric power. As examples of pumps made by the micromachining technique, there are those which use thermal deformations, piezoelectric substances, and electrostatic forces.

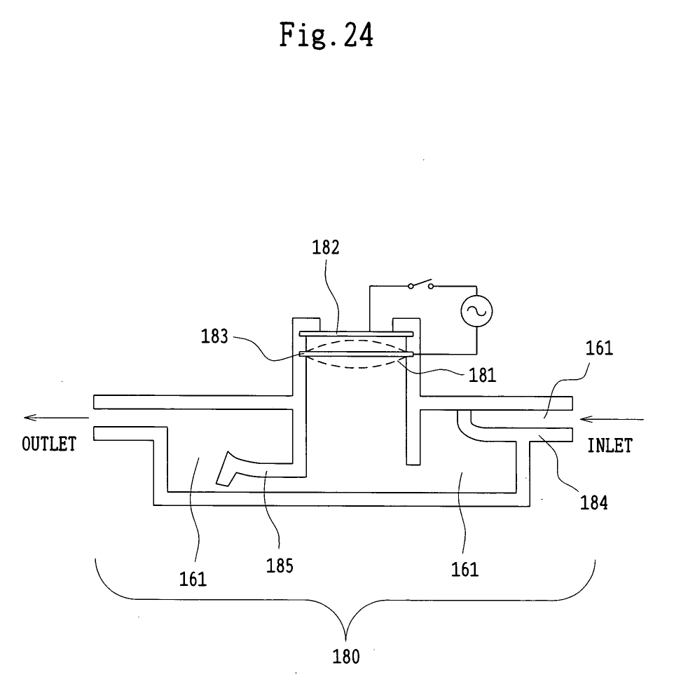

FIG. 24 shows an example of a micropump applicable to the variable mirror used in the optical system of the present invention. In the micropump 180, a vibrating plate 181 is vibrated by the electrostatic force or the electric force of the piezoelectric effect. In this figure, a case where the vibrating plate is vibrated by the electrostatic force is shown and reference numerals 182 and 183 represent electrodes. Dotted lines indicate the vibrating plate 181 where it is deformed. When the vibrating plate 181 is vibrated, two valves 184 and 185 are opened and closed to feed the fluid 161 from the right to the left.

In the deformable mirror 188 of the example, the reflecting film 189 is deformed into a concave or convex surface in accordance with the amount of the fluid 161, and thereby the surface of the reflecting film 189 functions as the deformable mirror. The deformable mirror 188 is driven by the fluid 161. An organic or inorganic substance, such as silicon oil, air, water, or jelly, can be used as the fluid.

In the deformable mirror or the variable focal-length lens which uses the electrostatic force or the piezoelectric effect, a high voltage is sometimes required for drive. In this case, for example, as shown in FIG. 22, it is desirable that the boosting transformer or the piezoelectric transformer is used to constitute the control system.

If the thin film 409a for reflection is provided as a portion which is not deformed, it can be used as a reference surface when the profile of the deformable mirror is measured by an interferometer, which is convenient.

FIG. 25 shows a variable focal-length mirror that utilizes a variable focal-length lens applicable to the optical system of the present invention. A variable focal-length mirror 565 includes a first transparent substrate 566 having a first surface 566a and a second surface 566b, and a second transparent substrate 567 having a third surface 567a and a fourth surface 567b. The first transparent substrate 566 is configured into a flat plate or lens shape to provide the transparent electrode 513a on the inner surface (the second surface) 566b. The second transparent substrate 567 is such that the inner surface (the third surface) 567a is configured as a concave surface, on which a reflecting film 568 is deposited, and the transparent electrode 513b is provided on the reflecting film 568. Between the transparent electrodes 513a and 513b, a macromolecular dispersed liquid crystal layer 514 is sandwiched so that the transparent electrodes 513a and 513b are connected to the alternating-current power supply 516 through the switch 515 and the variable resistor 519, and the alternating-current voltage is applied to the macromolecular dispersed liquid crystal layer 514. Also, in FIG. 25, the liquid crystal molecules are omitted. In this example, a variable focal-length lens including the transparent electrode 513a, the liquid crystal layer 514, and the transparent electrode 513b is combined with a concave mirror including the transparent substrate 567 and the reflecting film 568.

According to the above structure, since a ray of light incident from the side of the transparent substrate 566 is passed again through the liquid crystal layer 514 by the reflecting film 568, the function of the liquid crystal layer 514 can be exercised twice, and the focal position of reflected light can be shifted by changing the voltage applied to the liquid crystal layer 514. In this case, the ray of light incident on the variable focal-length mirror 565 is transmitted twice through the liquid crystal layer 514, and therefore when a thickness twice that of the liquid crystal layer 514 is represented by t, the conditions mentioned above can be used. Moreover, the inner surface of the transparent substrate 566 or 567 can also be configured into a diffraction grating shape to reduce the thickness of the liquid crystal layer 514. By doing so, the amount of scattered light can be decreased.

In the above description, in order to prevent the deterioration of the liquid crystal, the alternating-current power supply 516 is used as a voltage source to apply the alternating-current voltage to the liquid crystal layer. However, a direct-current power supply is used and thereby a direct-current voltage can also be applied to the liquid crystal layer. Techniques of shifting the orientation of the liquid crystal molecules, in addition to changing the voltage, can be achieved by changing the frequency of the electric field applied to the liquid crystal layer, the strength and frequency of the magnetic field applied to the liquid crystal layer, or the temperature of the liquid crystal layer. Also, in the present invention, it is assumed that the variable focal-length mirror whose shape is not changed, such as that shown in FIG. 25, comes into the category of the deformable mirror.

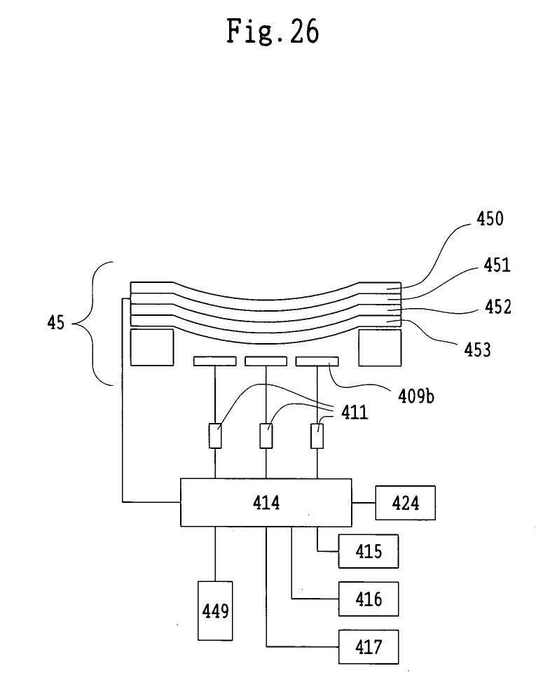

FIG. 26 shows another example of the variable mirror used in the optical system of the present invention. This example is described on the assumption that the deformable mirror is used in the digital camera. Again, in FIG. 26, reference numeral 411 designates the variable resistors; 414, the arithmetical unit; 415, the temperature sensor; 416, the humidity sensor; 417, the range sensor; and 424, the shake sensor.

A deformable mirror 45 of the example is such that a plurality of divided electrodes 409b are spaced away from an electrostrictive substance 453 including an organic substance such as acrylic elastomer, on which an electrode 452 and a deformable substrate 451 are placed in turn, and a reflecting film 450 including metal, such as aluminum, for reflecting incident light is provided on the substrate 451. The deformable mirror, when constructed as mentioned above, has the merit that the surface profile of the reflecting film 450 becomes smooth and it is hard to produce aberration, in contrast to the case where the divided electrodes 409b and the electrostrictive substance 453 are integrally constructed. Also, the deformable substrate 451 and the electrode 452 may be arranged in reverse order.

In FIG. 26, reference numeral 449 stands for a button for changing the magnification of the optical system or zooming. The deformable mirror 45 is controlled through the arithmetical unit 414 so that a user pushes the button 449 and thereby the reflecting film 450 can be deformed to change the magnification or zoom. Also, instead of the electrostrictive substance including an organic substance such as acrylic elastomer, the piezoelectric substance such as barium titanate, already mentioned, may be used.

Finally, the definitions of terms used in the present invention will be described.

The optical apparatus refers to an apparatus including an optical system or optical elements. The optical apparatus need not necessarily function by itself. That is, it may be thought of as a part of an apparatus. The optical apparatus includes an imaging device, an observation device, a display device, an illumination device, and a signal processing device.

The imaging device refers to, for example, a film camera, a digital camera, a robot's eye, a lens-exchangeable digital single-lens reflex camera, a TV camera, a moving-picture recorder, an electronic moving-picture recorder, a cam corder, a VTR camera, an electronic endoscope, or a digital camera for mobile phones. Any of the digital camera, a card digital camera, the TV camera, the VTR camera, a moving-picture recording camera, and the digital camera for mobile phones is an example of an electronic imaging device.

The observation device refers to, for example, a microscope, a telescope, spectacles, binoculars, a magnifier, a fiber scope, a finder, or a viewfinder.

The display device includes, for example, a liquid crystal display, a viewfinder, a game machine (Play Station by Sony), a video projector, a liquid crystal projector, a head mounted display (HMD), a personal digital assistant (PDA), or a mobile phone.

The illumination device includes, for example, a stroboscopic lamp for cameras, a headlight for cars, a light source for endoscopes, or a light source for microscopes.

The signal processing device refers to, for example, a mobile phone, a personal computer, a game machine, a read/write device for optical disks, or an arithmetic unit for optical computers.

Also, the optical system of the present invention is small in size and light in weight, and thus when the optical system is used in the electronic imaging device or the signal processing device, notably the digital camera or the imaging system of the mobile phone, a particular effect is brought about.

The image sensor refers to, for example, a CCD, a pickup tube, a solid-state image sensor, or a photographing film. The plane-parallel plate is included in one of prisms. A change of an observer includes a change in diopter. A change of an object includes a change in object distance, the displacement of the object, the movement of the object, vibration, or the shake of the object.

An extended surface is defined as follows:

Any shape such as a spherical, planar, or rotationally symmetrical aspherical surface; a spherical, planar, or rotationally symmetrical aspherical surface which is decentered with respect to the optical axis; an aspherical surface with symmetrical surfaces; an aspherical surface with only one symmetrical surface; an aspherical surface with no symmetrical surface; a free-formed surface; a surface with a nondifferentiable point or line; etc. is satisfactory. Moreover, any surface which has some effect on light, such as a reflecting or refracting surface, is satisfactory. In the present invention, it is assumed that such a surface is generally referred as to the extended surface.

The variable optical-property element includes a variable focal-length lens, a deformable mirror, a deflection prism whose surface profile is changed, a variable angle prism, a variable diffraction optical element in which the function of light deflection is changed, namely a variable HOE, or a variable DOE. The variable focal-length lens also includes a variable lens such that the focal length is not changed, but the amount of aberration is changed. The same holds for the case of the deformable mirror. In a word, an optical element in which the function of light deflection, such as reflection, refraction, or diffraction, can be changed is called the variable optical-property element.

An information transmitter refers to a device which is capable of inputting and transmitting any information from a mobile phone; a stationary phone; a remote control for game machines, TVs, radio-cassette tape recorders, or stereo sound systems; a personal computer; or a keyboard, mouse, or touch panel for personal computers. It also includes a TV monitor with the imaging device, or a monitor or display for personal computers. The information transmitter is included in the signal processing device.

1. An optical system having at least one deformable mirror so that focusing can be performed by only deformation of the deformable mirror.

2. An optical system according to claim 1, wherein the deformable mirror is changed into a rotationally asymmetrical shape in a preset state in order to reduce decentering aberration.

3. An optical system according to claim 1 or 2, wherein at least one rotationally symmetrical lens or an imaging plane is decentered with respect to a Z axis in order to correct decentering aberration.

4. An optical apparatus using an optical system, the optical system having at least one deformable mirror so that focusing can be performed by only deformation of the deformable mirror.

5. An optical system and an optical apparatus using the optical system having at least one deformable mirror so that focusing can be performed by only deformation of the deformable mirror, the deformable mirror being constructed so that as an object distance for focusing is reduced, positive power is increased.

6. An optical system according to claim 1, wherein the deformable mirror is constructed so that one of positive power and negative power can be assumed by the deformation.

7. An optical system according to claim 1, wherein the deformable mirror is constructed so that only positive power can be assumed.

8. An optical system according to claim 1, wherein the deformable mirror is constructed so that when a mirror surface is deformed, a periphery of the mirror is fixed.

9. An optical system according to claim 1, further having at least one cemented lens.

10. An optical system including a deformable mirror, wherein the optical system satisfies the following condition in a preset state:
0<|md/fl|<0.1
where md is a maximum amount of deformation of the deformable mirror and fl is a focal length of the optical system where the deformable mirror has a planar surface.

11. An optical system including a deformable mirror, wherein the optical system satisfies the following condition in a preset state:
0<md²/Sm<5.0×10⁻⁴
where md is a maximum amount of deformation of the deformable mirror and Sm is an area of an optically effective reflecting surface in the deformable mirror.

12. An optical system including a deformable mirror, wherein the optical system satisfies the following condition in a preset state:
0≦|Vm|<500
where Vm (volt) is a voltage applied to the deformable mirror in focusing.

13. An optical system including a deformable mirror, wherein the optical system satisfies the following condition in a preset state:
0≦|φDM×fl|<1.00
where φDM is a power of the deformable mirror and fl is a focal length of the optical system, in which the power φDM of the deformable mirror is an average value of a power φDMy in a plane in a decentering direction (a Y direction) of the deformable mirror and a power φDMx in a plane in a direction perpendicular to the Y direction (an X direction), and is defined as φDM=(φDMx+φDMy)/2.

14. An optical system according to claim 13, wherein when focusing is performed at a far point by the deformable mirror, the deformable mirror can be deformed to have lower power than in focusing.

15. An optical system according to claim 13, wherein when focusing is performed at a near point by the deformable mirror, the deformable mirror can be deformed to have higher power than in focusing.

16. An optical system according to claim 1 or 13, wherein when focusing is performed by the deformable mirror at the object point where the object distance is infinite, the deformable mirror is deformed not into a planar surface, but into a concave surface having larger power than zero.

17. An optical system including a deformable mirror, wherein the optical system has a lens unit with negative power on an object side of the deformable mirror and satisfies the following condition:
−5.0<fl/fl<−0.2
where fl is a focal length of the lens unit and fl is a focal length of the optical system.

18. An optical system according to claim 17, wherein the lens unit with negative power located on the object side of the deformable mirror is constructed with a single concave lens.

19. An optical system according to claim 17, wherein the lens unit with negative power located on the object side of the deformable mirror is constructed with two lenses.

20. An optical system according to claim 1, wherein the optical system satisfies the following condition:
60°<θ<120°
where an angle where an axial chief ray is bent by the deformable mirror.

21. An optical system including a deformable mirror, wherein the optical system satisfies the following condition:
0.35<|β1|<1.50
where β1 is a magnification of a lens unit ranging from an optical surface situated immediately behind the deformable mirror to a last surface.

22. An optical system including a deformable mirror, wherein the optical system satisfies the following condition:
1.0<Cj/fl<20.0
where Cj is an overall length of the optical system and fl is a focal length of the optical system.

23. An optical system including a deformable mirror, wherein at least one lens is shifted in order to correct decentering aberration produced by the deformable mirror and the optical system satisfies the following condition in a preset state:
0.0≦|δ/fl|<1.00
where δ is an amount of shift of the lens and fl is a focal length of the optical system.

24. An optical system according to claim 23, wherein a lens unit with negative power placed on an object side of the deformable mirror is constructed with two lenses and the optical system satisfies the following condition:
δ₁×δ₂≦0
where δ₁ and δ₂ are shifts applied to the two lenses.

25. An optical system including a deformable mirror, wherein at least one lens or an imaging plane is tilted in order to correct decentering aberration produced by the deformable mirror, and the optical system satisfies the following condition in a preset state:
0.0°≦|ε|<10.00
where ε is the amount of tilt applied to the lens or the imaging plane.

26. An optical system according to claim 25, wherein, of absolute values of amounts of tilt applied to individual lenses or the imaging plane, the absolute value of the amount of tilt of the imaging plane is largest.

27. An optical system according to claim 25, wherein that a direction of tilt applied to the imaging plane is a direction approaching parallel to the deformable mirror.

28. An optical system including a deformable mirror and applying a shift and tilt to at least one lens or an imaging plane in order to correct decentering aberration produced by the deformable mirror, wherein the shift takes place in a certain plane and a rotary axis of the tilt is perpendicular to the plane.

29. An optical system according to claim 1, wherein a stop of the optical system is located on an image side of the deformable mirror.
